(19) United States
(12) Patent Application Publication
(10) Pub. No.: US 2025/0159704 A1
(43) Pub. Date: May 15, 2025

(54) USER EQUIPMENT UPLINK ANTENNA PANEL SWITCHING FOR SIMULTANEOUS UPLINK TRANSMISSION

(71) Applicant: QUALCOMM Incorporated, San Diego, CA (US)

(72) Inventors: Fang YUAN, Beijing (CN); Wooseok NAM, San Diego, CA (US); Tao LUO, San Diego, CA (US)

(21) Appl. No.: 18/715,624

(22) PCT Filed: Feb. 9, 2022
(86) PCT No.: PCT/CN2022/075629

§ 371 Date: May 31, 2024

(51) Int. Cl. H04W 72/51; H04B 7/0404; H04W 72/21

(52) U.S. Cl. CPC H04W 72/51; H04B 7/0404; H04W 72/21

(57) ABSTRACT

Certain aspects of the present disclosure provide techniques for wireless communication. A method for wireless communication by a user equipment (UE) generally includes signaling, to a network entity, one or more capabilities of the UE for uplink panel switching associated with simultaneous multiple-panel (multi-panel) uplink transmission. The method generally includes receiving, from the network entity, an uplink panel switching configuration for the UE in response to the one or more capabilities of the CE.

### BACKGROUND

### Field of the Disclosure

Aspects of the present disclosure relate to wireless communications, and more particularly, to techniques for user equipment (UE) uplink antenna panel switching for simultaneous uplink transmission.

### Description of Related Art

Wireless communication systems are widely deployed to provide various telecommunication services such as telephony, video, data, messaging, broadcasts, or other similar types of services. These wireless communication systems may employ multiple-access technologies capable of supporting communication with multiple users by sharing available wireless communication system resources with those users

Although wireless communication systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communication systems, increasing the ability for different types of devices to intercommunicate, increasing the number and type of wireless communication mediums available for use, and the like. Consequently, there exists a need for further improvements in wireless communications systems to overcome the aforementioned technical challenges and others.

### SUMMARY

One aspect provides a method for wireless communication by a user equipment (UE). The method generally includes signaling, to a network entity, one or more capabilities of the UE for uplink panel switching associated with simultaneous multiple-panel (multi-panel) uplink transmission. The method generally includes receiving, from the network entity, an uplink panel switching configuration for the UE in response to the one or more capabilities of the UE.

One aspect provides a method for wireless communication by a network entity. The method generally includes receiving one or more capabilities of a UE for uplink panel switching associated with simultaneous multiple-panel (multi-panel) uplink transmission. The method generally includes providing an uplink panel switching configuration for the UE in response to the one or more capabilities of the UE.

Other aspects provide: an apparatus operable, configured, or otherwise adapted to perform the aforementioned methods as well as those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 is a block diagram conceptually illustrating an example wireless communication network.

FIG. 2 is a block diagram conceptually illustrating aspects of an example base station (BS) and an example user equipment (UE).

FIGS. 3A, 3B, 3C, and 3D depict various example aspects of data structures for a wireless communication network.

FIG. 4 depicts an example process flow for communication in a network between a BS and a UE.

FIG. 5 depicts example uplink panel switching between a non-simultaneous uplink transmission and simultaneous uplink transmissions.

FIG. 6 depicts example uplink panel switching between simultaneous uplink transmissions and a non-simultaneous uplink transmission.

FIG. 7 depicts example uplink panel switching between a non-simultaneous uplink transmission and simultaneous uplink transmissions.

FIG. 8 depicts example uplink panel switching between non-simultaneous uplink transmissions.

FIG. 9 depicts a method for wireless communication by a UE.

FIG. 10 depicts a method for wireless communication by a BS.

FIG. 11 depicts aspects of an example communications device.

FIG. 12 depicts aspects of an example communications device.

FIG. 13 depicts an example disaggregated BS architecture.

### DETAILED DESCRIPTION

Aspects of the present disclosure provide apparatuses, methods, processing systems, and computer-readable mediums for user equipment (UE) uplink antenna panel switching for simultaneous uplink transmission.

A UE may be configured with multiple UE antenna panels. As used herein, a UE antenna panel may include an array of antenna elements configured to transmit using multiple UE antenna ports and layers for multiple-input multiple-output (MIMO) transmission. With multiple UE antenna panels, the UE may support simultaneous multiple panel (multi-panel) uplink (UL) transmission. For example, each antenna panel may be used to form a beam (e.g., with two UE antenna panels, the UE may transmit two beams simultaneously).

Simultaneous multi-panel UL transmission may use spatial division multiplexing (SDM) and/or frequency division multiplexing (FDM). A simultaneous multi-panel UL transmission may be performed by the UE simultaneously transmitting with multiple panels in a component carrier (CC) (corresponding to a carrier frequency) or by the UE simultaneously transmitting individual transmissions with different panels in different CCs.

In some cases, the UE may switch between simultaneous UL transmission (where the UE transmits with multiple UE antenna panels) and non-simultaneous UL transmission (where the UE only transmits with one UE antenna panel), and between simultaneous UL transmission in one CC and simultaneous UL transmissions in multiple CCs. In such cases, the UE performs panel switching. Uplink panel switching may involve the UE tuning one or more UE antenna panels from one uplink CC to another uplink CC. Such panel switching takes time at the UE. The time needed for panel switching may depend on a capability of the UE. If the UE is scheduled for two UL transmissions that require panel switching at the UE, and the time between the two UL transmissions is shorter than the panel switching capability of the UE, the UE will not have time to retune the antenna panels and the scheduled UL transmission may fail.

Accordingly, techniques and apparatus for UE antenna panel switching to support simultaneous multi-panel UL transmission are provided.

According to certain aspects provided herein, a UE is configured to indicate its capability for uplink panel switching among different CCs. In some aspects, the UE indicates its capability for uplink panel switching per band (frequency band) combination. In some aspects, the UE indicates its capability for simultaneous multi-panel UL transmission on a single CC, on different CCs, or both. In some aspects, the UE indicates a minimum uplink panel switching gap duration.

According to certain aspects provided herein, the UE is configured by a network entity for uplink panel switching. The UE may be configured by the network entity for uplink panel switching in response to the UE indicating its capability for uplink panel switching among different CCs. The UE may be configured by the network entity for uplink panel switching, per band or band combination.

According to certain aspects provided herein, when the UE is configured for uplink panel switching between two UL transmissions, the UE may apply the minimum uplink panel switching gap duration between the two UL transmissions where the UE is not scheduled/configured to transmit, so that the UE can perform the panel switching during that time. Accordingly, the network may schedule the two UL transmissions separated in time by at least the minimum uplink panel switching gap duration.

According to certain aspects provided herein, the UE determines that the UE is not scheduled or configured for simultaneous multi-panel UL transmission on a CC and also scheduled or configured for UL transmission on another CC at the same time.

Signaling the UE capabilities for uplink panel switching allows the network to schedule uplink transmissions for the UE, such that the UE has sufficient time to perform the uplink panel switching. As such, the UE can dynamically switch between simultaneous and non-simultaneous UL transmission as well as between simultaneous UL transmission on a single CC or on multiple CCs. Accordingly, the UL transmission by the UE does not fail due to insufficient time to perform the uplink panel switching, thereby increasing reliability of communication, and reducing latency by avoiding failure recovery procedures.

### Introduction to Wireless Communication Networks

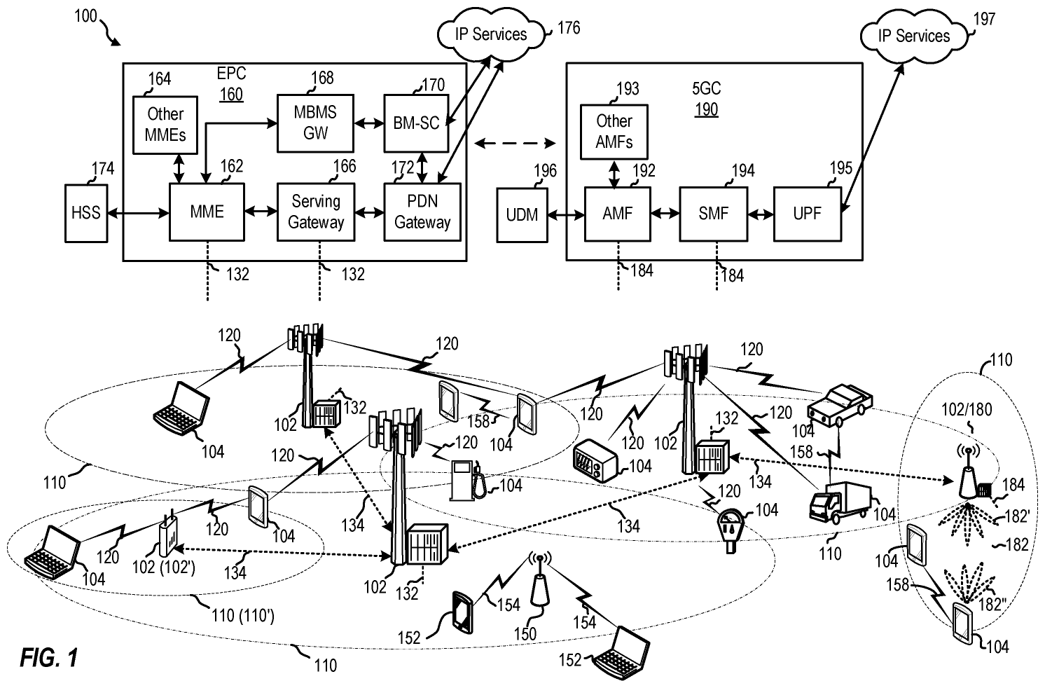

FIG. 1 depicts an example of a wireless communication network 100, in which aspects described herein may be implemented.

Generally, wireless communication network 100 includes various network entities (alternatively, network elements or network nodes), which are generally logical entities associated with, for example, a communication device and/or a communication function associated with a communication device. For example, various functions of a network as well as various devices associated with and interacting with a network may be considered network entities.

In the depicted example, wireless communication network 100 includes base stations (BSs) 102, user equipments (UEs) 104, and one or more core networks, such as an Evolved Packet Core (EPC) 160 and 5G Core (5GC) network 190, which interoperate to provide communications services over various communications links, including wired and wireless links.

BSs 102 wirelessly communicate with UEs 104 via communications links 120. The communication links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communication links 120 may use multiple-input and multiple-output (MIMO) antenna technology, including spatial multiplexing, beamforming, and/or transmit diversity in various aspects.

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, base station 180 and the UE 104 may each include a plurality of antennas, such as antenna elements, antenna panels, and/or antenna arrays to facilitate the beamforming. In some cases, base station 180 may transmit a beamformed signal to UE 104 in one or more transmit directions 182′. UE 104 may receive the beamformed signal from the base station 180 in one or more receive directions 182″. UE 104 may also transmit a beamformed signal to the base station 180 in one or more transmit directions 182″. Base station 180 may also receive the beamformed signal from UE 104 in one or more receive directions 182′. Base station 180 and UE 104 may then perform beam training to determine the best receive and transmit directions for each of base station 180 and UE 104. Notably, the transmit and receive directions for base station 180 may or may not be the same. Similarly, the transmit and receive directions for UE 104 may or may not be the same.

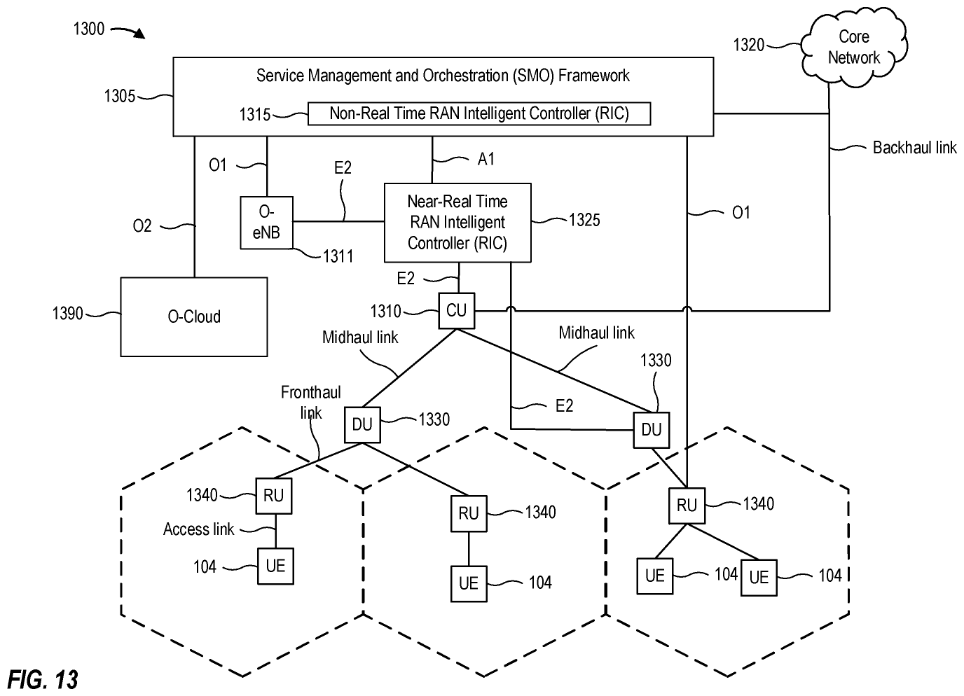

In various aspects, a network entity or network node can be implemented as an aggregated base station, a disaggregated base station, an integrated access and backhaul (IAB) node, a relay node, or a sidelink node, to name a few examples. FIG. 13, discussed in further detail later in this disclosure, depicts an example disaggregated BS architecture.

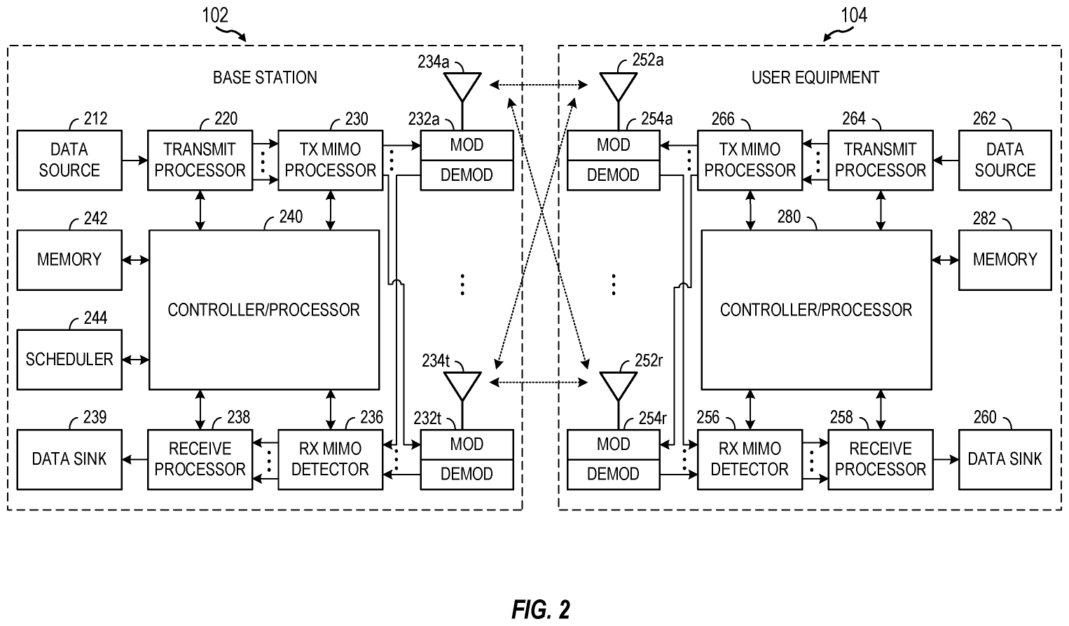

FIG. 2 depicts aspects of an example BS 102 and a UE 104.

Generally, BS 102 includes various processors (e.g., 220, 230, 238, and 240), antennas 234a-t (collectively 234), transceivers 232a-t (collectively 232), which include modulators and demodulators, and other aspects, which enable wireless transmission of data (e.g., data source 212) and wireless reception of data (e.g., data sink 239). For example, BS 102 may send and receive data between itself and UE 104. BS 102 includes controller/processor 240, which may be configured to implement various functions described herein related to wireless communications.

Generally, UE 104 includes various processors (e.g., 258, 264, 266, and 280), antennas 252a-r (collectively 252), transceivers 254a-r (collectively 254), which include modulators and demodulators, and other aspects, which enable wireless transmission of data (e.g., data source 262) and wireless reception of data (e.g., data sink 260). UE 104 includes controller/processor 280, which may be configured to implement various functions described herein related to wireless communications.

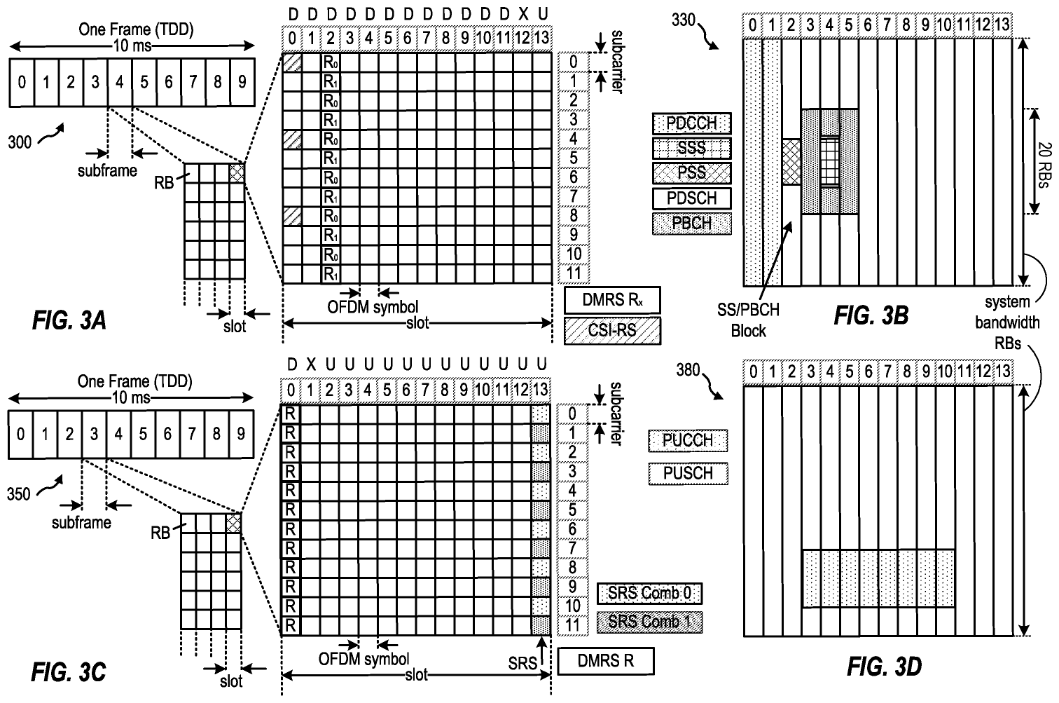

FIGS. 3A, 3B, 3C, and 3D depict aspects of data structures for a wireless communication network, such as wireless communication network 100 of FIG. 1. In particular, FIG. 3A is a diagram 300 illustrating an example of a first subframe within a 5G (e.g., 5G NR) frame structure, FIG. 3B is a diagram 330 illustrating an example of DL channels within a 5G subframe, FIG. 3C is a diagram 350 illustrating an example of a second subframe within a 5G frame structure, and FIG. 3D is a diagram 380 illustrating an example of UL channels within a 5G subframe.

Further discussions regarding FIG. 1, FIG. 2, FIGS. 3-3D, and FIG. 13 are provided later in this disclosure.

### Aspects Related to Uplink Transmit Switching

In certain wireless communication systems, such as 3GPP Release-16 systems and beyond (e.g., TS 38.214 v16.8.0, Section 6.1.6), a user equipment (UE) (e.g., a UE 104 illustrated in FIGS. 1-2) is configured for uplink transmit switching. As used herein, uplink transmit switching refers to the UE switching a transmit chain and port between uplink transmissions.

One example use for uplink transmit switching is to enable dynamic uplink multiple-input multiple-output (MIMO) for a UE with two transmit chains (and two antenna ports). For example, in inter-band uplink carrier aggregation (CA), a combination of bands may be aggregated (e.g., a 3.5 GHz band and a 2.1 GHz band). The UE may dynamically switch between using a first mode in which the UE uses a first transmit chain (and a first port) for transmission for a first band and a second transmit chain (and a second port) for a simultaneous transmission on a second band and a second mode in which the UE both transmit chains (and both ports) for simultaneously transmitting in a band. In order to switch between the two modes, the UE first performs uplink transmit switching. Similarly, the UE may perform uplink transmit switching for supplemental uplink (SUL) without Evolved-Universal Terrestrial Radio Access (E-UTRA) and new radio (NR) dual connectivity (EN-DC) and inter-band EN-DC without SUL.

With SUL, the UE is configured with two UL CCs for one DL CC of the same cell. With SUL, the UE can be scheduled to transmit on the primary UL CC or the SUL CC, but not on both at the same time. Uplink transmissions on the UL CCs are controlled by the network to avoid overlapping uplink transmissions at the same time. Accordingly, uplink transmit switching may be used when the UE switches between transmission on the primary UL and the SUL CC.

EN-DC allows the UE to communicate with the network using tight interworking with a simultaneous connection to an NR BS and an LTE BS. Communications may be via a master cell group (MCG), secondary cell group (SCG), or split radio bearer (SRB). Accordingly, uplink transmit switching may be used when the UE switches between transmission on the MCG, SCG, and SRB.

### Aspects Related to Uplink Panel Switching

In certain systems, a UE can perform multi-panel uplink transmission (e.g., for multi-transmission reception point (TRP) operation, where a TRP may be associated with a transmission configuration indicator (TCI) state and UE antenna panel). Multi-panel uplink transmission may provide higher uplink throughput and reliability.

In some example use cases, multi-panel uplink transmission may be used for customer premises equipment (CPE), fixed wireless access (FWA), vehicular communications, and industrial devices. Multi-panel uplink transmission may use uplink precoding. A UE using two panels for multi-panel uplink transmission may transmit using up to four layers and two codewords.

Simultaneous multi-panel uplink transmission may be scheduled by a single downlink control information (DCI) or multiple DCI (mDCI). The DCI may indicate one or more transmission configuration indicator (TCI) states to indicate the uplink beams for the simultaneous multi-panel uplink transmission.

Simultaneous multi-panel uplink transmission may be for transmissions in a same component carrier (CC) or different CCs. Simultaneous multi-panel uplink transmission may be for a physical uplink shared channel (PUSCH), a physical uplink control channel (PUCCH), or PUSCH and PUCCH.

As discussed above, a UE may dynamically switch between non-simultaneous uplink transmission and simultaneous multi-panel uplink transmission, as well as between simultaneous multi-panel uplink transmission on a same CC or on different CCs.

### Example Operations of Entities in a Communication Network

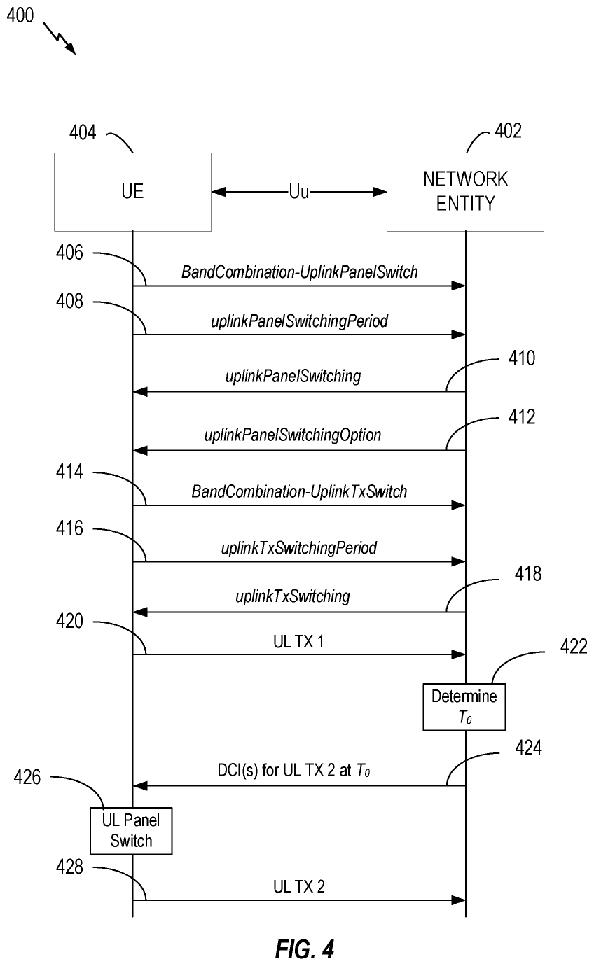

FIG. 4 depicts a process flow 400 for communication in a network between a network entity 402 and a user equipment (UE) 404. As discussed above, a network entity can be implemented as an aggregated base station, a disaggregated base station, an integrated access and backhaul (IAB) node, a relay node, or a sidelink node, to name a few examples. In some aspects, the network entity 402 may be an example of the BS 102 depicted and described with respect to FIGS. 1 and 2. Similarly, the UE 404 may be an example of UE 104 depicted and described with respect to FIGS. 1 and 2. However, in other aspects, UE 404 may be another type of wireless communication device and network entity 402 may be another type of network entity or network node, such as those described herein.

According to certain aspects, UE 404 indicates its capability for uplink panel switching among different CCs (e.g., at 406, 408, 414, 416 discussed in process flow 400 below) and UE 404 may be configured by the network (e.g., at 410, 412, and 418 discussed in process flow 400 below), such as network entity 402, for uplink panel switching in response to the indicated UE capability. Based on the UE capabilities, the network may schedule the UE 404 for uplink transmissions with uplink panel switching (e.g., at 422 and 424 discussed in process flow 400 below). The UE 404 performs uplink transmissions with uplink panel switching between the uplink transmissions (e.g., at 420, 426, and 428 discussed in process flow 400 below.

At 406, UE 404 indicates its capability for uplink panel switching with a parameter (e.g., for at least one band or band combination), such as with parameter BandCombination-UplinkPanelSwitch for a band combination. UE 404 may indicate for each band or band combination, whether uplink panel switching is supported. In some aspects, the parameter BandCombination-UplinkPanelSwitch is a radio resource control (RRC) parameter.

At 408, UE 404 indicates a time gap duration needed for UE 404 to perform uplink panel switching, such as with a parameter uplinkPanelSwitchingPeriod. In some aspects, the parameter uplinkPanelSwitchingPeriod is an RRC parameter.

While process flow 400 depicts BandCombination-UplinkPanelSwitch and uplinkPanelSwitching Period as separately signaled, it should be understood that certain of these parameters may be signaled together (e.g., in a single information element (IE)).

At 410, network entity 402 configures the UE 404 for uplink panel switching, such as with the parameter uplinkPanelSwitching. Network entity 402 may indicate for each band or band combination, whether uplink panel switching is configured for the UE 404. In some aspects, the parameter uplinkPanelSwitching is a RRC parameter. In some aspects, network entity 402 configures bands or band combinations for uplink panel switching for which the UE 404 indicates that it supports uplink panel switching (e.g., in the BandCombination-UplinkPanelSwitch parameter) and the band or band combination is configured with uplink carrier aggregation, supplemental uplink (SUL), or Evolved-Universal Terrestrial Radio Access (E-UTRA) and new radio (NR) dual connectivity (EN-DC).

At 412, network entity 402 further configures the UE 404 for simultaneous multi-panel UL transmission, such as on a single uplink component carrier (CC) with the parameter uplinkPanelSwitchingOption. The parameter uplinkPanelSwitchingOption may be set to “dual panel” to indicate that the UE 404 can perform simultaneous multi-panel UL transmission on a single uplink CC. In some aspects, network entity 402 indicates the parameter uplinkPanelSwitchingOption per band or band combination. In some aspects, the parameter uplinkPanelSwitchingOption is an RRC parameter.

While process flow 400 depicts uplinkPanelSwitching and uplinkPanelSwitchingOption as separately signaled, it should be understood that certain these parameters may be signaled together (e.g., in a single IE).

According to certain aspects, UE 404 indicates its capability for uplink transmit switching. UE 404 may be configured by the network, such as network entity 402, for uplink transmit switching in response to the indicated UE capability.

At 414, UE 404 indicates its capability for uplink transmit switching (e.g., for a band or band combination), such as with a parameter BandCombination-UplinkTxSwitch for a band combination. UE 404 may indicate for each band combination, whether uplink transmit switching is supported. In some aspects, the parameter BandCombination-UplinkTransmitSwitch is an RRC parameter.

At 416, UE 404 indicates a time gap duration needed for the UE 404 to perform uplink transmit switching, such as with a parameter uplinkTxSwitchingPeriod. In some aspects, the parameter uplinkTxSwitchingPeriod is an RRC parameter.

While process flow 400 depicts the parameters BandCombination-UplinkTxSwitch and uplinkTxSwitchingPeriod as separately signaled, it should be understood that certain these parameters may be signaled together (e.g., in a single IE). In addition, while the parameters BandCombination-UplinkTxSwitch and uplinkTxSwitchingPeriod are shown signaled after the parameters BandCombination-UplinkPanelSwitch and uplinkPanelSwitchingPeriod, it should be understood that the parameters BandCombination-UplinkTxSwitch and uplinkTxSwitchingPeriod may be signaled before or together with the parameters BandCombination-UplinkPanelSwitch and uplinkPanelSwitchingPeriod.

At 418, network entity 402 configures the UE 404 for uplink transmit switching, such as with the parameter uplinkTxSwitching. Network entity 402 may indicate for each band or band combination, whether uplink transmit switching is configured for the UE 404. In some aspects, the parameter uplinkTxSwitching is an RRC parameter. In some aspects, network entity 402 configures band combinations for uplink transmit switching for which the UE 404 indicates support for uplink transmit switching (e.g., in the BandCombination-UplinkTxSwitch parameter) and the band combination is configured with uplink carrier aggregation, SUL, or EN-DC.

While process flow 400 depicts the parameter uplinkTxSwitching after the parameters BandCombination-UplinkTxSwitch and uplinkTxSwitchingPeriod, it should be understood that the parameter uplinkTxSwitching may be signaled before or together with the parameters BandCombination-UplinkTxSwitch and uplinkTxSwitchingPeriod.

At 420, UE 404 sends a first uplink transmission to network entity 402. The first uplink transmission may be a non-simultaneous transmission, a simultaneous multi-panel UL transmission on a single CC, or simultaneous multi-panel UL transmissions on different CCs. A simultaneous multi-panel UL transmission in a single CC may be scheduled by a single downlink control information (DCI) or by multiple DCIs (mDCI). A simultaneous multi-panel UL transmission on same or different CCs may be simultaneous physical uplink control channels (PUCCHs), simultaneous physical uplink shared channels (PUSCHs), or a simultaneous PUCCH and PUSCH. Uplink transmission associated with a panel may be identified by an explicit panel ID, or an implicit panel ID. For implicit panel ID, the uplink transmissions may be configured or associated with another ID by signaling or based on a fixed rule, where different panels are associated with different IDs. In some aspect, the other ID may be an ID of control resource set (CORESET) pool index for downlink control signaling, an ID of a TCI state, an ID of closed loop index for the uplink transmission, or an ID of an associated sounding reference signal (SRS) resource set for the uplink transmission.

At 422, network entity 402 determines a time, T₀, to schedule a start of a second uplink transmission. According to certain aspects, network entity 402 determines T₀ such that the second uplink transmission satisfies a first threshold, T_{offset}, duration from the DCI scheduling the second uplink transmission. That is, if the DCI scheduling the second uplink transmission is transmitted at T_{DCI}, then network entity 402 schedules the second uplink transmission such that T₀−T_{DCI}≥T_{offset}. T_{offset} may be a capability of the UE 404 that defines a minimum amount of processing time needed by the UE to prepare an uplink transmission. T_{offset} may be based on a type of the uplink transmission. For example, T_{offset} may be a UE channel state information (CSI) computation time, a SRS preparation and/or switching time, a PUSCH preparation time, and/or other processing time of the UE between a DCI and uplink transmission scheduled by the DCI. Determining a time for scheduling a start of the second uplink transmission, To, that satisfies T₀−T_{DCI}≥T_{offset} ensures that the UE has sufficient time to prepare the uplink transmission.

In addition, where the second uplink transmission being scheduled requires the UE 404 to perform uplink panel switching, network entity 402 further determines T₀ such that the UE 404 has sufficient time to perform the uplink panel switching. Accordingly, network entity 402 further determines T₀ such that an uplink panel switching gap is provided. In some examples, network entity 402 schedules the duration of the uplink panel switching gap, N_{TX1-TX2}, based on the UE capability uplinkPanelSwitchingPeriod signaled by UE 404 at 408. For example, the value signaled by uplinkPanelSwitchingPeriod may correspond to a minimum uplink panel switching gap duration for the uplink panel switching. Thus, network entity 402 may determine T₀ that satisfies both T₀−T_{DCI}≥N_{TX1-TX2} and T₀−T_{TX1}≥N_{TN1-TX2}, where T_{TX1} corresponds to a last symbol of the previous uplink transmission (UL TX 1) at 420, in addition to satisfying T₀−T_{DCI}≥T_{offset}. In other words, network entity 402 ensures that the second uplink transmission is scheduled to begin after the uplink panel switching gap from the DCI and after the uplink panel switching gap from the previous uplink transmission.

In addition to determining T₀ for scheduling the second uplink transmission to include the uplink panel switching gap, network entity 402 may also ensure that UE 404 is not scheduled for any other uplink transmission to occur during the uplink panel switching gap.

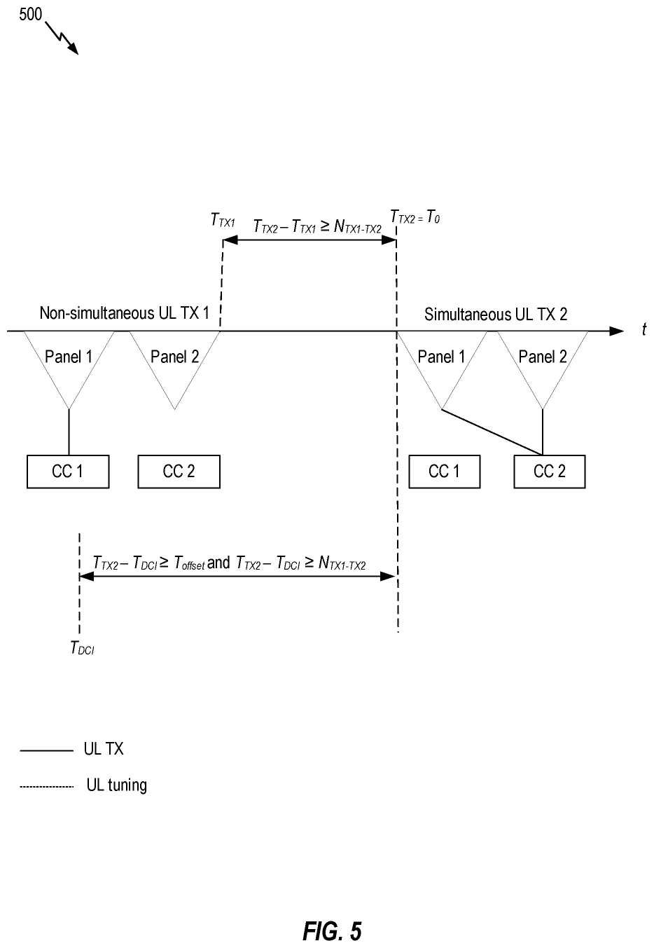

According to certain aspects, in order to determine that the uplink panel switching gap is needed, network entity 402 may first determine that uplink panel switching is needed between the first uplink transmission and the second uplink transmission. FIGS. 5-8, discussed in more detail below, depict example uplink panel switching scenarios.

At 424, network entity 402 transmits one or more DCI(s) (e.g., a single DCI (sDCI) or mDCI) to UE 404 to schedule the second uplink transmission to start at the determined To. Additionally or alternatively, UE 404 may be configured to transmit the second uplink transmission by higher layer configuration. For example, UE 404 may be persistently or semi-persistently scheduled for uplink transmission.

At 426, UE 404 performs UL panel switching. For example, UE 404 may retune one or more of its panels from one frequency band to a different frequency band.

At 428, UE 404 transmit the second uplink transmission (e.g., UL TX 2).

According to certain aspects, where UE 404 receives a DCI scheduling an uplink transmission without sufficient processing time for UE 404 to prepare the uplink transmission (e.g., where T₀−T_{DCI}<T_{offset}), UE 404 may cancel the uplink transmission. Similarly, where UE 404 is scheduled for an uplink transmission without sufficient time for UE 404 to perform uplink panel switching (e.g., where T₀−T_{TX1}<N_{TX1-TX2}), and where uplink panel switching is needed to scheduled uplink transmission, UE 404 may cancel the uplink transmission.

According to certain aspects, UE 404 may omit uplink transmission during the uplink switching gap N_{TX1-TX2}, if UE 404 indicated a capability for uplink switching with BandCombination-UplinkPanelSwitch for a band combination, and if that band combination is configured with EN-DC, UL CA, or SUL, the UE is configured with uplinkPanelSwitching, and uplink panel switching is triggered.

FIGS. 5-8 described below depict various scenarios where the UE performs uplink panel switching. The UE may perform the uplink panel switching for the scenarios depicted in FIGS. 5-8 when the UE has indicated a capability for uplink switching with the parameter BandCombination-UplinkPanelSwitch for a band combination, that band combination configured with uplink carrier aggregation, the UE is configured with uplink switching with the parameter uplinkPanelSwitching, and the UE is to transmit in the uplink based on one or more DCI(s) received before T₀−T_{offset} or based on one or more higher layer configuration(s).

FIG. 5 depicts example uplink panel switching between a non-simultaneous uplink transmission and simultaneous uplink transmissions. When the UE is to transmit simultaneous transmissions on one uplink carrier and if the preceding uplink transmission is a non-simultaneous transmission on another uplink carrier, then the UE determines not to transmit and is not scheduled/configured to transmit for the duration of N_{TX1-TX2} on any of the two carriers. As shown, UE 404 performs a first non-simultaneous uplink transmission (UL TX 1 at 420) with UE antenna panel 1 on CC 1 and performs a second simultaneous multi-panel uplink transmission (UL TX 2 at 428) with both UE antenna panel 1 and UE antenna panel 2 on CC2. Accordingly, network entity 402 determines that the uplink panel switching gap is needed, and determines To to schedule the second simultaneous multi-panel uplink transmission (UL TX 2 at 428) such that the threshold To T₀−T_{TX1}≥N_{TX1-TX2} is satisfied. UE 104 performs uplink panel switching during the uplink panel switching gap, N_{TX1-TX2}, between the last symbol of non-simultaneous UL TX 1 at T_{TX1}, and the first symbol of simultaneous UL TX 2 at T₀, to retune UE antenna panel 1 from CC1 to CC2 (e.g., and potentially also to tune UE antenna panel 2 to CC2 if UE antenna panel 2 was not already tuned to CC2).

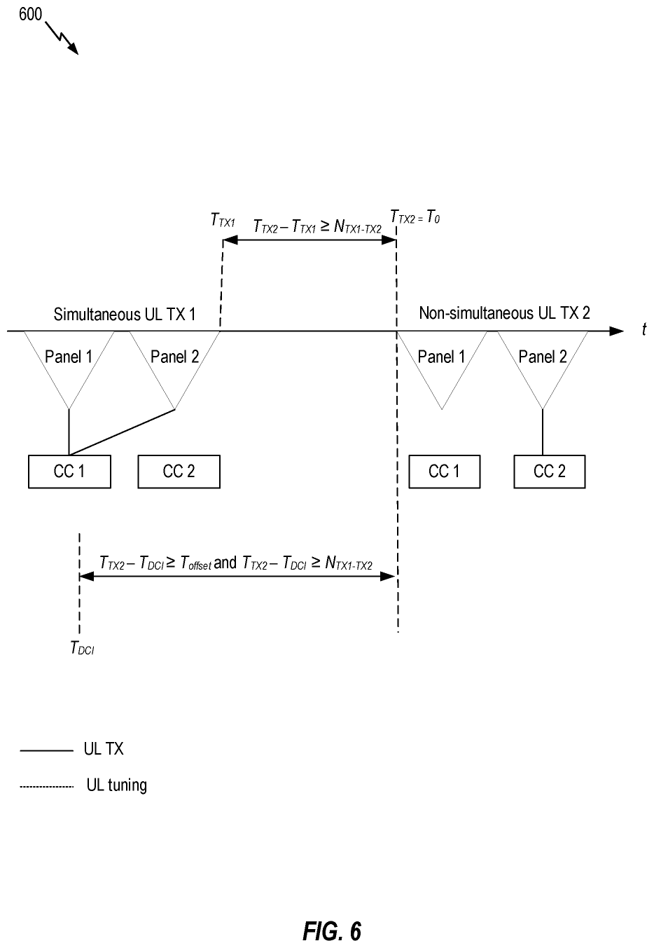

FIG. 6 depicts example uplink panel switching between simultaneous uplink transmissions and a non-simultaneous uplink transmission. When the UE is to transmit a non-simultaneous transmission on one uplink carrier and if the preceding uplink transmission is simultaneous transmissions on another uplink carrier, then the UE is not expected to transmit for the duration of N_{TX1-TX2} on any of the two carriers. As shown, UE 404 performs a first simultaneous multi-panel uplink transmission (UL TX 1 at 420) with both UE antenna panel 1 and UE antenna panel 2 on CC 1 and performs a second non-simultaneous uplink transmission (UL TX 2 at 428) with UE antenna panel 2 on CC2. Accordingly, network entity 402 determines that the uplink panel switching gap is needed, and determines T₀ to schedule the second non-simultaneous uplink transmission (UL TX 2 at 428) such that the threshold T₀−T_{TX1}≥N_{TX1-TX2} is satisfied. UE 404 performs uplink panel switching during the uplink panel switching gap, N_{TX1-TX2}, between the last symbol of simultaneous UL TX 1 at T_{TX1}, and the first symbol of non-simultaneous UL TX 2 at To, to retune UE antenna panel 2 from CC1 to CC2.

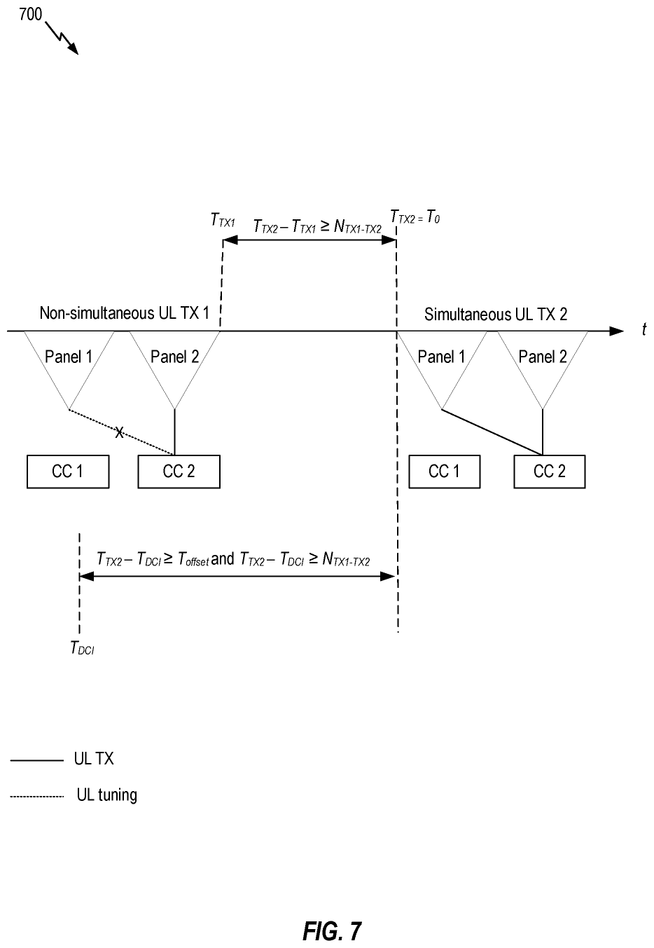

FIG. 7 depicts example uplink panel switching between a non-simultaneous uplink transmission and simultaneous uplink transmissions. For the UE configured with uplinkPanelSwitchingOption set to ‘dual panel’, when the UE is to transmit simultaneous transmissions on one uplink carrier and if the preceding uplink transmission was a non-simultaneous transmission on the same uplink carrier and the UE is under the operation state in which simultaneous transmissions cannot be supported in the same uplink carrier, then the UE is not expected to transmit for the duration of N_{TX1-TX2} on any of the two carriers. As shown, UE 404 performs a first non-simultaneous uplink transmission (UL TX 1 at 420) with UE antenna panel 2 on CC 2 where the UE 404 is configured for multi-panel uplink transmission, but does not support simultaneous uplink transmission in the same uplink CC. In this scenario, UE antenna panel 1 is not tuned to CC 2. UE 404 performs a second simultaneous multi-panel uplink transmission (UL TX 2 at 428) with both UE antenna panel 1 and UE antenna panel 2 on CC 2. Accordingly, network entity 402 determines that the uplink panel switching gap is needed, and determines T₀ to schedule the second simultaneous multi-panel uplink transmission (UL TX 2 at 428) such that the threshold T₀−T_{TX1}≥N_{TX1-TX2} is satisfied. UE 404 performs uplink panel switching during the uplink panel switching gap, N_{TX1-TX2}, between the last symbol of non-simultaneous UL TX 1 at T_{TX1}, and the first symbol of simultaneous UL TX 2 at T₀, to retune UE antenna panel 1 to CC 2.

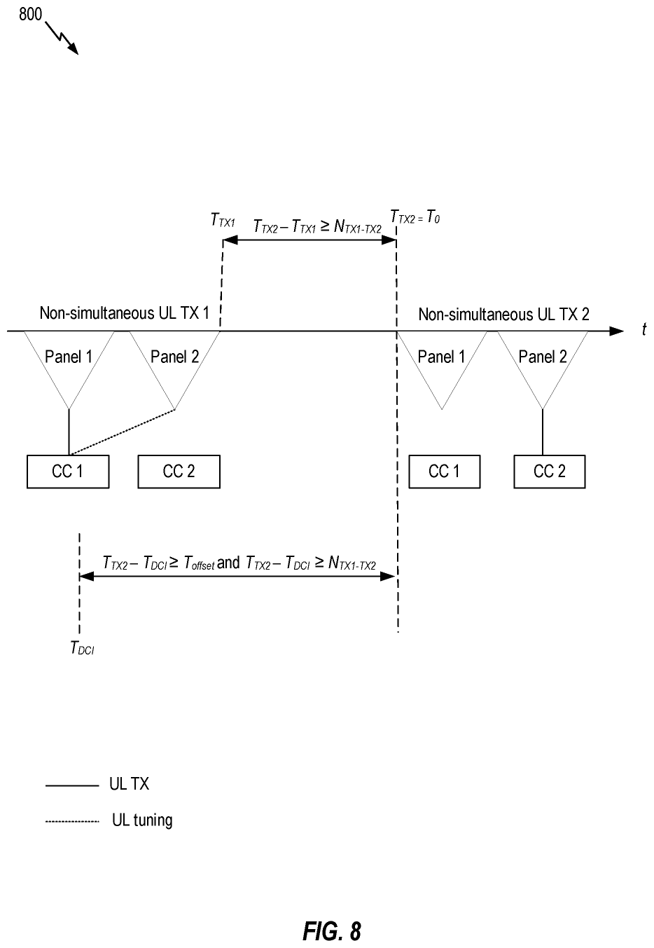

FIG. 8 depicts example uplink panel switching between non-simultaneous uplink transmissions. For the UE configured with uplinkPanelSwitchingOption set to ‘dual panel’, when the UE is to transmit a non-simultaneous transmission on one uplink carrier and if the preceding uplink transmission was a non-simultaneous transmission on another uplink carrier and the UE is under the operation state in which simultaneous transmissions can be supported on the same uplink carrier, then the UE is not expected to transmit for the duration of N_{TX1-TX2} on any of the two carriers. As shown, UE 404 performs a first non-simultaneous uplink transmission (UL TX 1 at 420) with UE antenna panel 1 on CC 1 where the UE 404 is configured for multi-panel uplink transmission and supports simultaneous uplink transmission in the same uplink CC. In this scenario, UE antenna panel 2 is tuned to CC 1, but is not used for the first non-simultaneous uplink transmission. UE 404 performs a second non-simultaneous uplink transmission (UL TX 2 at 428) with UE antenna panel 2 on CC 2. Accordingly, network entity 402 determines that the uplink panel switching gap is needed, and determines T₀ to schedule the second non-simultaneous uplink transmission (UL TX 2 at 428) such that the threshold T₀−T_{TX1}≥N_{TX1-TX2} is satisfied. UE 404 performs uplink panel switching during the uplink panel switching gap, N_{TX1-TX2}, between the last symbol of non-simultaneous UL TX 1 at T_{TX1}, and the first symbol of non-simultaneous UL TX 2 at T₀, to retune UE antenna panel 2 to CC2.

According to certain aspects, a UE does not expect to be scheduled or configured (and the network does not schedule or configure the UE) with uplink transmissions that result in simultaneous uplink transmissions using more panels than the UE supports. In an example, a UE may not expect to be scheduled or configured (and the network does not schedule or configure the UE) with simultaneous transmission using two panels on one uplink carrier, and any transmission on another uplink carrier at the same time.

### Example Operations of a User Equipment

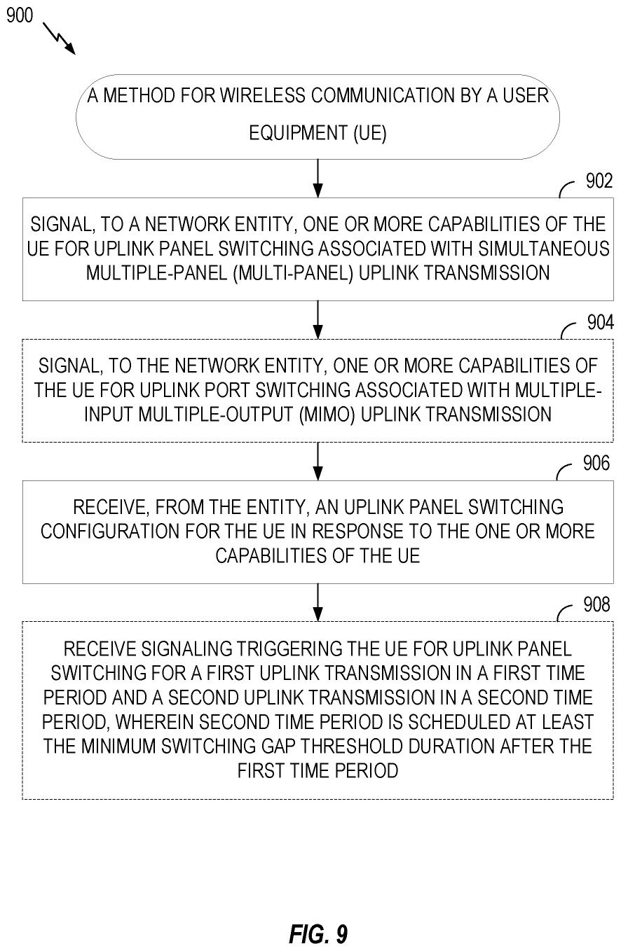

FIG. 9 shows a method 900 for wireless communication by a UE, such as UE 104 of FIGS. 1 and 2.

Method 900 begins at 902 with signaling, to a network entity, one or more capabilities of the UE for uplink panel switching associated with simultaneous multiple-panel (multi-panel) uplink transmission.

Optionally, method 900 then proceeds to step 904 with signaling, to the network entity, one or more capabilities of the UE for uplink port switching associated with multiple-input multiple-output (MIMO) uplink transmission.

Method 900 then proceeds to step 906 with receiving, from the network entity, an uplink panel switching configuration for the UE in response to the one or more capabilities of the UE.

Optionally, method 900 then proceeds to step 908 with receiving signaling triggering the UE for uplink panel switching for a first uplink transmission in a first time period and a second uplink transmission in a second time period. The second time period is scheduled at least the minimum switching gap threshold duration after the first time period.

Various aspects relate to the method 900, including the following aspects.

In one aspect, method 900 further includes receiving, from the network entity, an uplink port switching configuration for the UE in response to the one or more capabilities of the UE for uplink port switching.

In one aspect, the simultaneous multi-panel uplink transmission comprises a first uplink transmission by the UE on a first component carrier (CC) using a first UE antenna panel and, simultaneous with the first uplink transmission by the UE, a second uplink transmission by the UE on a second CC using a second UE antenna panel.

In one aspect, the simultaneous multi-panel uplink transmission comprises simultaneous uplink transmission by the UE on a component carrier (CC) using a first UE antenna panel and a second UE antenna panel.

In one aspect, the signaling of the one or more capabilities of the UE for uplink panel switching comprises signaling of the one or more capabilities of the UE for uplink panel switching for each band combination of a plurality of band combinations.

In one aspect, the signaling of the one or more capabilities of the UE for uplink panel switching comprises radio resource control signaling (RRC) or medium access control control element (MAC CE) signaling.

In one aspect, the signaling of the one or more capabilities of the UE for uplink panel switching comprises a BandCombination-UplinkPanelSwitch parameter indicating a band combination and whether uplink panel switching is supported by the UE for the band combination.

In one aspect, the one or more capabilities of the UE for uplink panel switching comprise a capability of the UE for simultaneous multi-panel uplink transmission with frequency division multiplexing (FDM).

In one aspect, the one or more capabilities of the UE for uplink panel switching comprise a capability of the UE for simultaneous multi-panel uplink transmission with spatial division multiplexing (SDM).

In one aspect, the one or more capabilities of the UE for uplink panel switching comprise a capability for single downlink control information (sDCI) scheduled simultaneous multi-panel uplink transmission.

In one aspect, the one or more capabilities of the UE for uplink panel switching comprise a capability for multiple downlink control information (mDCI) scheduled simultaneous multi-panel uplink transmission.

In one aspect, the one or more capabilities of the UE for uplink panel switching comprise a capability for simultaneous multi-panel uplink transmission on a first physical uplink control channel (PUCCH) and a second PUCCH.

In one aspect, the one or more capabilities of the UE for uplink panel switching comprise a capability for simultaneous multi-panel uplink transmission on a physical uplink control channel (PUCCH) and a physical uplink shared channel (PUCSH).

In one aspect, the one or more capabilities of the UE for uplink panel switching comprise a capability for simultaneous multi-panel uplink transmission on a first physical uplink shared channel (PUCSH) and a second PUSCH.

In one aspect, the uplink panel switching configuration for the UE comprises an indication of whether uplink panel switching is configured for each band combination of a plurality of band combinations.

In one aspect, the uplink panel switching configuration comprises an uplinkPanelSwitching parameter indicating a band combination and whether uplink panel switching is configured for the band combination.

In one aspect, the uplink panel switching configuration is received via radio resource control signaling (RRC) or medium access control control element (MAC CE) signaling.

In one aspect, the one or more capabilities includes a minimum switching gap threshold duration.

In one aspect, method 900 further includes: receiving first signaling scheduling a non-simultaneous uplink transmission on a first uplink component carrier (UL CC) in a first time period; and receiving second signaling scheduling a simultaneous multi-panel uplink transmission on a second UL CC in a second time period after the first time period. The second time period is scheduled at least a minimum switching gap threshold duration after the first time period.

In one aspect, method 900 further includes: receiving first signaling scheduling a simultaneous multi-panel uplink transmission on a first uplink component carrier (UL CC) in a first time period; and receiving second signaling scheduling a non-simultaneous uplink transmission on a second UL CC in a second time period after the first time period. The second time period is scheduled at least a minimum switching gap threshold duration after the first time period.

In one aspect, method 900 further includes: receiving first signaling scheduling a non-simultaneous uplink transmission on a first uplink component carrier (UL CC) in a first time period in which the UE is not configured to support simultaneous multi-panel uplink transmission on a same UL CC; and receiving second signaling scheduling a simultaneous multi-panel uplink transmission on the first UL CC in a second time period after the first time period. The second time period is scheduled at least a minimum switching gap threshold duration after the first time period.

In one aspect, method 900 further includes: receiving first signaling scheduling a first non-simultaneous uplink transmission on a first uplink component carrier (UL CC) in a first time period in which the UE is configured to support simultaneous multi-panel uplink transmission on the a UL CC; and receiving second signaling scheduling a second non-simultaneous uplink transmission on a second UL CC in a second time period after the first time period. The second time period is scheduled at least a minimum switching gap threshold duration after the first time period.

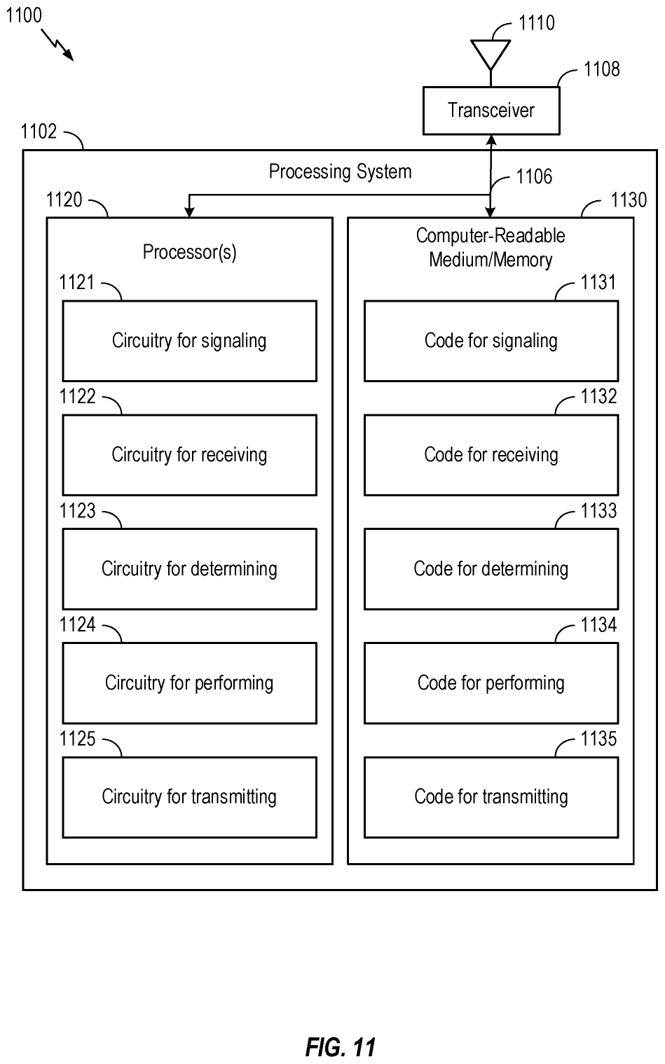

In one aspect, method 900, or any aspect related to it, may be performed by an apparatus, such as communications device 1100 of FIG. 11, which includes various components operable, configured, or adapted to perform the method 900. Communications device 1100 is described below in further detail.

Note that FIG. 9 is just one example of a method, and other methods including fewer, additional, a different ordering of, or alternative steps are possible consistent with this disclosure.

### Example Operations of a Network Entity

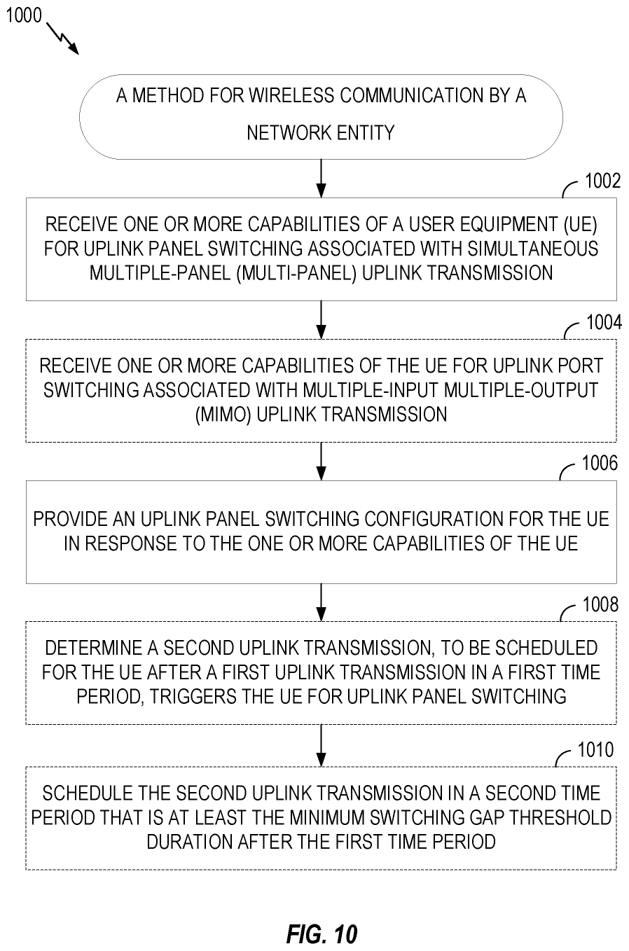

FIG. 10 shows a method 1000 for wireless communication by a network entity, such as BS 102 of FIGS. 1 and 2.

Method 1000 begins at 1002 with receiving one or more capabilities of a user equipment (UE) for uplink panel switching associated with simultaneous multiple-panel (multi-panel) uplink transmission.

Optionally, method 1000 then proceeds to step 1004 with receiving one or more capabilities of the UE for uplink port switching associated with multiple-input multiple-output (MIMO) uplink transmission.

Method 1000 then proceeds to step 1006 with providing an uplink panel switching configuration for the UE in response to the one or more capabilities of the UE.

Optionally, method 1000 then proceeds to step 1008 with determining a second uplink transmission, to be scheduled for the UE after a first uplink transmission in a first time period, triggers the UE for uplink panel switching.

Optionally, method 1000 then proceeds to step 1010 with scheduling the second uplink transmission in a second time period that is at least the minimum switching gap threshold duration after the first time period.

Various aspects relate to the method 1000, including the following aspects.

In one aspect, method 1000 further includes providing an uplink port switching configuration for the UE in response to the one or more capabilities of the UE for uplink port switching.

In one aspect, the simultaneous multi-panel uplink transmission comprises a first uplink transmission by the UE on a first component carrier (CC) using a first UE antenna panel and, simultaneous with the first uplink transmission by the UE, a second uplink transmission by the UE on a second CC using a second UE antenna panel.

In one aspect, the simultaneous multi-panel uplink transmission comprises simultaneous uplink transmission by the UE on a component carrier (CC) using a first UE antenna panel and a second UE antenna panel.

In one aspect, the one or more capabilities of the UE for uplink panel switching comprises one or more capabilities of the UE for each band combination of a plurality of band combinations.

In one aspect, the one or more capabilities of the UE for uplink panel switching are received via radio resource control signaling (RRC) or medium access control control element (MAC CE) signaling.

In one aspect, the one or more capabilities of the UE for uplink panel switching comprises a BandCombination-UplinkPanelSwitch parameter indicating a band combination and whether uplink panel switching is supported by the UE for the band combination.

In one aspect, the one or more capabilities of the UE for uplink panel switching comprise a capability of the UE for simultaneous multi-panel uplink transmission with frequency division multiplexing (FDM).

In one aspect, the one or more capabilities of the UE for uplink panel switching comprise a capability of the UE for simultaneous multi-panel uplink transmission with spatial division multiplexing (SDM).

In one aspect, the one or more capabilities of the UE for uplink panel switching comprise a capability for single downlink control information (sDCI) scheduled simultaneous multi-panel uplink transmission.

In one aspect, the one or more capabilities of the UE for uplink panel switching comprise a capability for multiple downlink control information (mDCI) scheduled simultaneous multi-panel uplink transmission.

In one aspect, the one or more capabilities of the UE for uplink panel switching comprise a capability for simultaneous multi-panel uplink transmission on a first physical uplink control channel (PUCCH) and a second PUCCH.

In one aspect, the one or more capabilities of the UE for uplink panel switching comprise a capability for simultaneous multi-panel uplink transmission on a physical uplink control channel (PUCCH) and a physical uplink shared channel (PUCSH).

In one aspect, the one or more capabilities of the UE for uplink panel switching comprise a capability for simultaneous multi-panel uplink transmission on a first physical uplink shared channel (PUCSH) and a second PUSCH.

In one aspect, the uplink panel switching configuration for the UE comprises an indication of whether uplink panel switching is configured for each band combination of a plurality of band combinations.

In one aspect, the uplink panel switching configuration comprises an uplinkPanelSwitching parameter indicating a band combination and whether uplink panel switching is configured for the band combination.

In one aspect, the uplink panel switching configuration is sent via radio resource control signaling (RRC) or medium access control control element (MAC CE) signaling.

In one aspect, the one or more capabilities includes a minimum switching gap threshold duration.

In one aspect, method 1000 further includes: scheduling the UE for a non-simultaneous uplink transmission on a first uplink component carrier (UL CC) in a first time period; and scheduling the UE for a simultaneous multi-panel uplink transmission on a second UL CC in a second time period that is at least a minimum switching gap threshold duration after the first time period.

In one aspect, method 1000 further includes: scheduling the UE for a simultaneous multi-panel uplink transmission on a first uplink component carrier (UL CC) in a first time period; and scheduling the UE for a non-simultaneous uplink transmission on a second UL CC in a second time period that is at least a minimum switching gap threshold duration after the first time period.

In one aspect, method 1000 further includes: scheduling the UE for a non-simultaneous uplink transmission on a first uplink component carrier (UL CC) in a first time period in which the UE is not configured to support simultaneous multi-panel uplink transmission on a same UL CC; and scheduling the UE for a simultaneous multi-panel uplink transmission on the first UL CC in a second time period that is at least a minimum switching gap threshold duration after the first time period.

In one aspect, method 1000 further includes: scheduling the UE for a first non-simultaneous uplink transmission on a first uplink component carrier (UL CC) in a first time period in which the UE is configured to support simultaneous multi-panel uplink transmission on the a UL CC; and scheduling the UE for a second non-simultaneous uplink transmission on a second UL CC in a second time period that is at least a minimum switching gap threshold duration after the first time period.

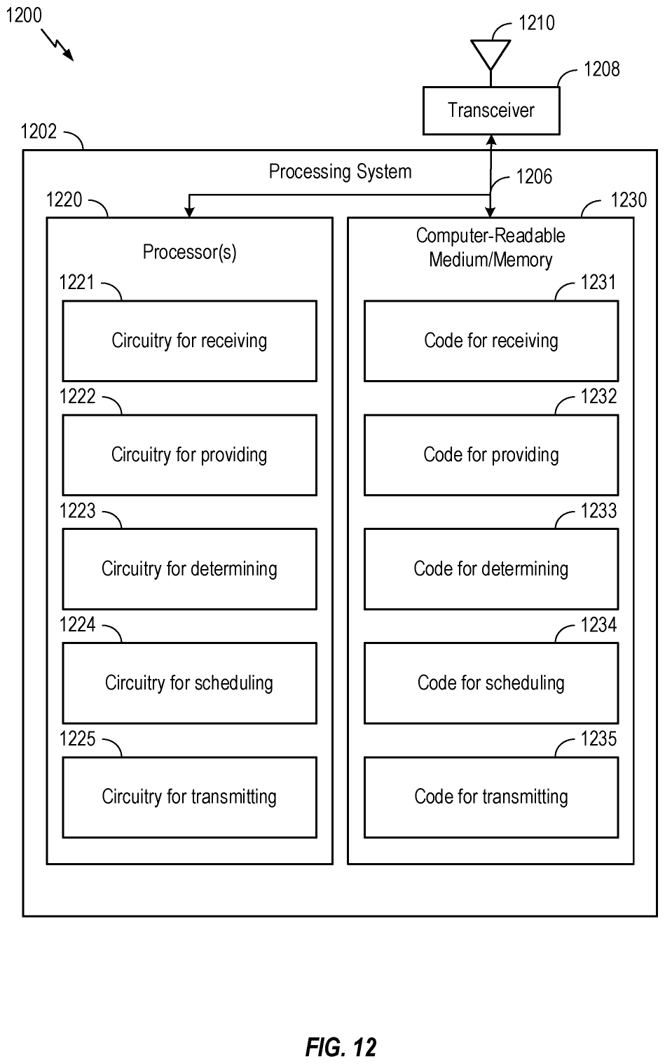

In one aspect, method 1000, or any aspect related to it, may be performed by an apparatus, such as communications device 1200 of FIG. 12, which includes various components operable, configured, or adapted to perform the method 1000. Communications device 1200 is described below in further detail.

Note that FIG. 10 is just one example of a method, and other methods including fewer, additional, or alternative steps are possible consistent with this disclosure.

### Example Communication Devices

FIG. 11 depicts aspects of an example communications device 1100. In some aspects, communications device 1100 is a user equipment, such as UE 104 described above with respect to FIGS. 1 and 2.

The communications device 1100 includes a processing system 1102 coupled to a transceiver 1108 (e.g., a transmitter and/or a receiver). The transceiver 1108 is configured to transmit and receive signals for the communications device 1100 via an antenna 1110, such as the various signals as described herein. The processing system 1102 may be configured to perform processing functions for the communications device 1100, including processing signals received and/or to be transmitted by the communications device 1100.

The processing system 1102 includes one or more processors 1120. In various aspects, the one or more processors 1120 may be representative of one or more of receive processor 258, transmit processor 264, TX MIMO processor 266, and/or controller/processor 280, as described with respect to FIG. 2. The one or more processors 1120 are coupled to a computer-readable medium/memory 1130 via a bus 1106. In certain aspects, the computer-readable medium/memory 1130 is configured to store instructions (e.g., computer-executable code) that when executed by the one or more processors 1120, cause the one or more processors 1120 to perform the method 900 described with respect to FIG. 9, or any aspect related to it. Note that reference to a processor performing a function of communications device 1100 may include one or more processors performing that function of communications device 1100.

In the depicted example, computer-readable medium/memory 1130 stores code (e.g., executable instructions) 1131 for signaling, code 1132 for receiving, code 1133 for determining, code 1134 for performing, and/or code 1135 for transmitting. Processing of the code 1131-1135 may cause the communication device 1100 to perform the method 900 described with respect to FIG. 9, or any aspect related to it.

The one or more processors 1120 include circuitry configured to implement (e.g., execute) the code stored in the computer-readable medium/memory 1130, including circuitry 1121 for signaling, circuitry 1122 for receiving, circuitry 1123 for determining, circuitry 1124 for performing, and/or circuitry 1125 for transmitting. Processing with circuitry 1121-1125 may cause the communication device 1100 to perform the method 900 described with respect to FIG. 9, or any aspect related to it.

Various components of the communications device 1100 may provide means for performing the method 900 described with respect to FIG. 9, or any aspect related to it. For example, means for transmitting, sending or outputting for transmission may include the transceivers 254 and/or antenna(s) 252 of the UE 104 illustrated in FIG. 2 and/or transceiver 1108 and antenna 1110 of the communication device 1100 in FIG. 11. Means for receiving or obtaining may include the transceivers 254 and/or antenna(s) 252 of the UE 104 illustrated in FIG. 2 and/or transceiver 1108 and antenna 1110 of the communication device 1100 in FIG. 11.

FIG. 12 depicts aspects of an example communications device 1200. In some aspects, communications device 1200 is a network entity, such as BS 102 described above with respect to FIGS. 1 and 2.

The communications device 1200 includes a processing system 1202 coupled to a transceiver 1208 (e.g., a transmitter and/or a receiver). The transceiver 1208 is configured to transmit and receive signals for the communications device 1200 via an antenna 1210, such as the various signals as described herein. The processing system 1202 may be configured to perform processing functions for the communications device 1200, including processing signals received and/or to be transmitted by the communications device 1200.

The processing system 1202 includes one or more processors 1220. In various aspects, one or more processors 1220 may be representative of one or more of receive processor 238, transmit processor 220, TX MIMO processor 230, and/or controller/processor 240, as described with respect to FIG. 2. The one or more processors 1220 are coupled to a computer-readable medium/memory 1230 via a bus 1206. In certain aspects, the computer-readable medium/memory 1230 is configured to store instructions (e.g., computer-executable code) that when executed by the one or more processors 1220, cause the one or more processors 1220 to perform the method 1000 described with respect to FIG. 10, or any aspect related to it. Note that reference to a processor of communications device 1200 performing a function may include one or more processors of communications device 1200 performing that function.

In the depicted example, the computer-readable medium/memory 1230 stores code (e.g., executable instructions) 1231 for receiving, code 1232 for providing, code 1233 for determining, code 1234 for scheduling, and/or code 1235 for transmitting. Processing of the code 1231-1234 may cause the communication device 1200 to perform the method 1000 described with respect to FIG. 10, or any aspect related to it.

The one or more processors 1220 include circuitry configured to implement (e.g., execute) the code stored in the computer-readable medium/memory 1230, including circuitry 1221 for receiving, code 1222 for providing, code 1223 for determining, code 1224 for scheduling, and/or code 1225 for transmitting. Processing with circuitry 1221-1225 may cause the communication device 1200 to perform the method 1000 as described with respect to FIG. 10, or any aspect related to it.

Various components of the communications device 1200 may provide means for performing the method 1000 as described with respect to FIG. 10, or any aspect related to it. Means for transmitting, sending or outputting for transmission may include the transceivers 232 and/or antenna(s) 234 of the BS 102 illustrated in FIG. 2 and/or transceiver 1208 and antenna 1210 of the communication device 1200 in FIG. 12. Means for receiving or obtaining may include the transceivers 232 and/or antenna(s) 234 of the BS 102 illustrated in FIG. 2 and/or transceiver 1208 and antenna 1210 of the communication device 1200 in FIG. 12.

### EXAMPLE CLAUSES

Implementation examples are described in the following numbered clauses:
Clause 1. A method for wireless communication by a user equipment (UE), the method comprising: signaling, to a network entity, one or more capabilities of the UE for uplink panel switching associated with simultaneous multiple-panel (multi-panel) uplink transmission; and receiving, from the network entity, an uplink panel switching configuration for the UE in response to the one or more capabilities of the UE.
Clause 2. The method of Clause 1, wherein the simultaneous multi-panel uplink transmission comprises a first uplink transmission by the UE on a first component carrier (CC) using a first UE antenna panel and, simultaneous with the first uplink transmission by the UE, a second uplink transmission by the UE on a second CC using a second UE antenna panel.
Clause 3. The method of any one or more of Clauses 1-2, wherein the simultaneous multi-panel uplink transmission comprises simultaneous uplink transmission by the UE on a component carrier (CC) using a first UE antenna panel and a second UE antenna panel.
Clause 4. The method of any one or more of Clauses 1-3, further comprising: signaling, to the network entity, one or more capabilities of the UE for uplink port switching associated with multiple-input multiple-output (MIMO) uplink transmission; and receiving, from the network entity, an uplink port switching configuration for the UE in response to the one or more capabilities of the UE for uplink port switching.
Clause 5. The method of any one or more of Clauses 1-4, wherein the signaling of the one or more capabilities of the UE for uplink panel switching comprises signaling of the one or more capabilities of the UE for uplink panel switching for each band combination of a plurality of band combinations.
Clause 6. The method of claim 1, wherein the signaling of the one or more capabilities of the UE for uplink panel switching comprises radio resource control signaling (RRC) or medium access control control element (MAC CE) signaling.
Clause 7. The method of any one or more of Clauses 1-5, wherein the signaling of the one or more capabilities of the UE for uplink panel switching comprises a BandCombination-UplinkPanelSwitch parameter indicating a band combination and whether uplink panel switching is supported by the UE for the band combination.
Clause 8. The method of any one or more of Clauses 1-7, wherein the one or more capabilities of the UE for uplink panel switching comprise a capability of the UE for simultaneous multi-panel uplink transmission with frequency division multiplexing (FDM).
Clause 9. The method of any one or more of Clauses 1-8, wherein the one or more capabilities of the UE for uplink panel switching comprise a capability of the UE for simultaneous multi-panel uplink transmission with spatial division multiplexing (SDM).
Clause 10. The method of any one or more of Clauses 1-9, wherein the one or more capabilities of the UE for uplink panel switching comprise a capability for single downlink control information (sDCI) scheduled simultaneous multi-panel uplink transmission.
Clause 11. The method of any one or more of Clauses 1-10, wherein the one or more capabilities of the UE for uplink panel switching comprise a capability for multiple downlink control information (mDCI) scheduled simultaneous multi-panel uplink transmission.
Clause 12. The method of any one or more of Clauses 1-11, wherein the one or more capabilities of the UE for uplink panel switching comprise a capability for simultaneous multi-panel uplink transmission on a first physical uplink control channel (PUCCH) and a second PUCCH.
Clause 13. The method of any one or more of Clauses 1-12, wherein the one or more capabilities of the UE for uplink panel switching comprise a capability for simultaneous multi-panel uplink transmission on a physical uplink control channel (PUCCH) and a physical uplink shared channel (PUCSH).
Clause 14. The method of any one or more of Clauses 1-13, wherein the one or more capabilities of the UE for uplink panel switching comprise a capability for simultaneous multi-panel uplink transmission on a first physical uplink shared channel (PUCSH) and a second PUSCH.
Clause 15. The method of any one or more of Clauses 1-14, wherein the uplink panel switching configuration for the UE comprises an indication of whether uplink panel switching is configured for each band combination of a plurality of band combinations.
Clause 16. The method of any one or more of Clauses 1-15, wherein the uplink panel switching configuration comprises an uplinkPanelSwitching parameter indicating a band combination and whether uplink panel switching is configured for the band combination.
Clause 17. The method of any one or more of Clauses 1-16, wherein the uplink panel switching configuration is received via radio resource control signaling (RRC) or medium access control control element (MAC CE) signaling.
Clause 18. The method of any one or more of Clauses 1-17, wherein the one or more capabilities includes a minimum switching gap threshold duration.
Clause 19. The method of any one or more of Clause 18, further comprising: receiving signaling triggering the UE for uplink panel switching for a first uplink transmission in a first time period and a second uplink transmission in a second time period, wherein second time period is scheduled at least the minimum switching gap threshold duration after the first time period.
Clause 20. The method of any one or more of Clauses 1-19, further comprising: receiving first signaling scheduling a non-simultaneous uplink transmission on a first uplink component carrier (UL CC) in a first time period; and receiving second signaling scheduling a simultaneous multi-panel uplink transmission on a second UL CC in a second time period after the first time period, wherein the second time period is scheduled at least a minimum switching gap threshold duration after the first time period.
Clause 21. The method of any one or more of Clauses 1-20, further comprising: receiving first signaling scheduling a simultaneous multi-panel uplink transmission on a first uplink component carrier (UL CC) in a first time period; and receiving second signaling scheduling a non-simultaneous uplink transmission on a second UL CC in a second time period after the first time period, wherein the second time period is scheduled at least a minimum switching gap threshold duration after the first time period.
Clause 22. The method of any one or more of Clauses 1-21, further comprising: receiving first signaling scheduling a non-simultaneous uplink transmission on a first uplink component carrier (UL CC) in a first time period in which the UE is not configured to support simultaneous multi-panel uplink transmission on a same UL CC; and receiving second signaling scheduling a simultaneous multi-panel uplink transmission on the first UL CC in a second time period after the first time period, wherein the second time period is scheduled at least a minimum switching gap threshold duration after the first time period.
Clause 23. The method of any one or more of Clauses 1-22, further comprising: receiving first signaling scheduling a first non-simultaneous uplink transmission on a first uplink component carrier (UL CC) in a first time period in which the UE is configured to support simultaneous multi-panel uplink transmission on the a UL CC; and receiving second signaling scheduling a second non-simultaneous uplink transmission on a second UL CC in a second time period after the first time period, wherein the second time period is scheduled at least a minimum switching gap threshold duration after the first time period.
Clause 24. A method for wireless communication by a network entity, the method comprising: receiving one or more capabilities of a user equipment (UE) for uplink panel switching associated with simultaneous multiple-panel (multi-panel) uplink transmission; and providing an uplink panel switching configuration for the UE in response to the one or more capabilities of the UE.
Clause 25. The method of Clause 24, wherein the simultaneous multi-panel uplink transmission comprises a first uplink transmission by the UE on a first component carrier (CC) using a first UE antenna panel and, simultaneous with the first uplink transmission by the UE, a second uplink transmission by the UE on a second CC using a second UE antenna panel.
Clause 26. The method of any one or more of Clauses 24-25, wherein the simultaneous multi-panel uplink transmission comprises simultaneous uplink transmission by the UE on a component carrier (CC) using a first UE antenna panel and a second UE antenna panel.
Clause 27. The method of any one or more of Clauses 24-26, further comprising: receiving one or more capabilities of the UE for uplink port switching associated with multiple-input multiple-output (MIMO) uplink transmission; and providing an uplink port switching configuration for the UE in response to the one or more capabilities of the UE for uplink port switching.
Clause 28. The method of any one or more of Clauses 24-27, wherein the one or more capabilities of the UE for uplink panel switching comprises one or more capabilities of the UE for each band combination of a plurality of band combinations.
Clause 29. The method of any one or more of Clauses 24-28, wherein the one or more capabilities of the UE for uplink panel switching are received via radio resource control signaling (RRC) or medium access control control element (MAC CE) signaling.
Clause 30. The method of any one or more of Clauses 24-29, wherein the one or more capabilities of the UE for uplink panel switching comprises a BandCombination-UplinkPanelSwitch parameter indicating a band combination and whether uplink panel switching is supported by the UE for the band combination.
Clause 31. The method of any one or more of Clauses 24-30, wherein the one or more capabilities of the UE for uplink panel switching comprise a capability of the UE for simultaneous multi-panel uplink transmission with frequency division multiplexing (FDM).
Clause 32. The method of any one or more of Clauses 24-31, wherein the one or more capabilities of the UE for uplink panel switching comprise a capability of the UE for simultaneous multi-panel uplink transmission with spatial division multiplexing (SDM).
Clause 33. The method of any one or more of Clauses 24-32, wherein the one or more capabilities of the UE for uplink panel switching comprise a capability for single downlink control information (sDCI) scheduled simultaneous multi-panel uplink transmission.
Clause 34. The method of any one or more of Clauses 24-33, wherein the one or more capabilities of the UE for uplink panel switching comprise a capability for multiple downlink control information (mDCI) scheduled simultaneous multi-panel uplink transmission.
Clause 35. The method of any one or more of Clauses 24-34, wherein the one or more capabilities of the UE for uplink panel switching comprise a capability for simultaneous multi-panel uplink transmission on a first physical uplink control channel (PUCCH) and a second PUCCH.
Clause 36. The method of any one or more of Clauses 24-35, wherein the one or more capabilities of the UE for uplink panel switching comprise a capability for simultaneous multi-panel uplink transmission on a physical uplink control channel (PUCCH) and a physical uplink shared channel (PUCSH).
Clause 37. The method of any one or more of Clauses 24-36, wherein the one or more capabilities of the UE for uplink panel switching comprise a capability for simultaneous multi-panel uplink transmission on a first physical uplink shared channel (PUCSH) and a second PUSCH.
Clause 38. The method of any one or more of Clauses 24-37, wherein the uplink panel switching configuration for the UE comprises an indication of whether uplink panel switching is configured for each band combination of a plurality of band combinations.
Clause 39. The method of any one or more of Clauses 24-38, wherein the uplink panel switching configuration comprises an uplinkPanelSwitching parameter indicating a band combination and whether uplink panel switching is configured for the band combination.
Clause 40. The method of any one or more of Clauses 24-39, wherein the uplink panel switching configuration is sent via radio resource control signaling (RRC) or medium access control control element (MAC CE) signaling.
Clause 41. The method of any one or more of Clauses 24-40, wherein the one or more capabilities includes a minimum switching gap threshold duration.
Clause 42. The method of Clause 41, further comprising: determining a second uplink transmission, to be scheduled for the UE after a first uplink transmission in a first time period, triggers the UE for uplink panel switching; and scheduling the second uplink transmission in a second time period that is at least the minimum switching gap threshold duration after the first time period.
Clause 43. The method of any one or more of Clauses 24-42, further comprising: scheduling the UE for a non-simultaneous uplink transmission on a first uplink component carrier (UL CC) in a first time period; and scheduling the UE for a simultaneous multi-panel uplink transmission on a second UL CC in a second time period that is at least a minimum switching gap threshold duration after the first time period.
Clause 44. The method of any one or more of Clauses 24-43, further comprising: scheduling the UE for a simultaneous multi-panel uplink transmission on a first uplink component carrier (UL CC) in a first time period; and scheduling the UE for a non-simultaneous uplink transmission on a second UL CC in a second time period that is at least a minimum switching gap threshold duration after the first time period.
Clause 45. The method of any one or more of Clauses 24-44, further comprising: scheduling the UE for a non-simultaneous uplink transmission on a first uplink component carrier (UL CC) in a first time period in which the UE is not configured to support simultaneous multi-panel uplink transmission on a same UL CC; and scheduling the UE for a simultaneous multi-panel uplink transmission on the first UL CC in a second time period that is at least a minimum switching gap threshold duration after the first time period.
Clause 46. The method of any one or more of Clauses 24-45, further comprising: scheduling the UE for a first non-simultaneous uplink transmission on a first uplink component carrier (UL CC) in a first time period in which the UE is configured to support simultaneous multi-panel uplink transmission on the a UL CC; and scheduling the UE for a second non-simultaneous uplink transmission on a second UL CC in a second time period that is at least a minimum switching gap threshold duration after the first time period.
Clause 47: An apparatus, comprising: a memory comprising executable instructions; and a processor configured to execute the executable instructions and cause the apparatus to perform a method in accordance with any one of Clauses 1-46.
Clause 48: An apparatus, comprising means for performing a method in accordance with any one of Clauses 1-46.
Clause 49: A non-transitory computer-readable medium comprising executable instructions that, when executed by a processor of an apparatus, cause the apparatus to perform a method in accordance with any one of Clauses 1-46.
Clause 50: A computer program product embodied on a computer-readable storage medium comprising code for performing a method in accordance with any one of Clauses 1-46.

### Additional Wireless Communication Network Considerations

The techniques and methods described herein may be used for various wireless communications networks. While aspects may be described herein using terminology commonly associated with 3G, 4G, and/or 5G wireless technologies, aspects of the present disclosure may likewise be applicable to other communication systems and standards not explicitly mentioned herein.

Returning to FIG. 1, various aspects of the present disclosure may be performed within the example wireless communication network 100.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

FIG. 1 depicts various example BSs 102, which may more generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and others. Each of BSs 102 may provide communication coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communication coverage for a macro cell (covering relatively large geographic area), a pico cell (covering relatively smaller geographic area, such as a sports stadium), a femto cell (relatively smaller geographic area (e.g., a home)), and/or other types of cells.

While BSs 102 are depicted in various aspects as unitary communication devices, BSs 102 may be implemented in various configurations. For example, one or more components of base station may be disaggregated, including a central unit (CU), one or more distributed units (DUs), one or more radio units (RUs), a radio unit (RU), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture.

Different BSs 102 within wireless communication network 100 may also be configured to support different radio access technologies, such as 3G, 4G, and 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communication network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 600 MHz-6 GHz, which is often referred to (interchangeably) as “Sub-6 GHz”. Similarly, 3GPP currently defines Frequency Range 2 (FR2) as including 26-41 GHz, which is sometimes referred to (interchangeably) as a “millimeter wave” (“mmW” or “mmWave”). A base station configured to communicate using mmWave/near mmWave radio frequency bands (e.g., a mmWave base station such as BS 180) may utilize beamforming (e.g., 182) with a UE (e.g., 104) to improve path loss and range.

The communication links 120 between BSs 102 and, for example, UEs 104, may be through one or more carriers, which may have different bandwidths (e.g., 5, 10, 15, 20, 100, 400, and other MHz), and which may be aggregated in various aspects. Carriers may or may not be adjacent to each other. Allocation of carriers may be asymmetric with respect to DL and UL (e.g., more or fewer carriers may be allocated for DL than for UL).

Wireless communication network 100 further includes a Wi-Fi AP 150 in communication with Wi-Fi stations (STAs) 152 via communication links 154 in, for example, a 2.4 GHz and/or 5 GHz unlicensed frequency spectrum.

Certain UEs 104 may communicate with each other using device-to-device (D2D) communication link 158. D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172 in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QOS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

Returning to FIG. 2, various example components of a BS 102 and a UE 104 are depicted, which may be used to implement aspects of the present disclosure.

In regards to an example downlink transmission, BS 102 includes a transmit processor 220 that may receive data from a data source 212 and control information from a controller/processor 240. The control information may be for the physical broadcast channel (PBCH), physical control format indicator channel (PCFICH), physical HARQ indicator channel (PHICH), physical downlink control channel (PDCCH), group common PDCCH (GC PDCCH), and others. The data may be for the physical downlink shared channel (PDSCH), in some examples.

Transmit processor 220 may process (e.g., encode and symbol map) the data and control information to obtain data symbols and control symbols, respectively. Transmit processor 220 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) in transceivers 232a-232t. Each modulator in transceivers 232a-232t may process a respective output symbol stream to obtain an output sample stream. Each modulator may further process (e.g., convert to analog, amplify, filter, and upconvert) the output sample stream to obtain a downlink signal. Downlink signals from the modulators in transceivers 232a-232t may be transmitted via the antennas 234a-234t, respectively.

In order to receive the downlink transmission, UE 104 includes antennas 252a-252r that may receive the downlink signals from the BS 102 and may provide received signals to the demodulators (DEMODs) in transceivers 254a-254r, respectively. Each demodulator in transceivers 254a-254r may condition (e.g., filter, amplify, downconvert, and digitize) a respective received signal to obtain input samples. Each demodulator may further process the input samples to obtain received symbols.

MIMO detector 256 may obtain received symbols from all the demodulators in transceivers 254a-254r, perform MIMO detection on the received symbols if applicable, and provide detected symbols. Receive processor 258 may process (e.g., demodulate, deinterleave, and decode) the detected symbols, provide decoded data for the UE 104 to a data sink 260, and provide decoded control information to a controller/processor 280.

In regards to an example uplink transmission, UE 104 further includes a transmit processor 264 that may receive and process data (e.g., for the PUSCH) from a data source 262 and control information (e.g., for the physical uplink control channel (PUCCH)) from the controller/processor 280. Transmit processor 264 may also generate reference symbols for a reference signal (e.g., for the sounding reference signal (SRS)). The symbols from the transmit processor 264 may be precoded by a TX MIMO processor 266 if applicable, further processed by the modulators in transceivers 254a-254r (e.g., for SC-FDM), and transmitted to BS 102.

At BS 102, the uplink signals from UE 104 may be received by antennas 234a-t, processed by the demodulators in transceivers 232a-232t, detected by a MIMO detector 236 if applicable, and further processed by a receive processor 238 to obtain decoded data and control information sent by UE 104. Receive processor 238 may provide the decoded data to a data sink 239 and the decoded control information to the controller/processor 240.

Memories 242 and 282 may store data and program codes for BS 102 and UE 104, respectively.

Scheduler 244 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 212, scheduler 244, memory 242, transmit processor 220, controller/processor 240, TX MIMO processor 230, transceivers 232a-t, antenna 234a-t, and/or other aspects described herein. Similarly, “receiving” may refer to various mechanisms of obtaining data, such as obtaining data from antennas 234a-t, transceivers 232a-t, RX MIMO detector 236, controller/processor 240, receive processor 238, scheduler 244, memory 242, and other aspects described herein.

In various aspects, UE 104 may likewise be described as transmitting and receiving various types of data associated with the methods described herein. In these contexts, “transmitting” may refer to various mechanisms of outputting data, such as outputting data from data source 262, memory 282, transmit processor 264, controller/processor 280, TX MIMO processor 266, transceivers 254a-t, antenna 252a-t, and/or other aspects described herein. Similarly, “receiving” may refer to various mechanisms of obtaining data, such as obtaining data from antennas 252a-t, transceivers 254a-t, RX MIMO detector 256, controller/processor 280, receive processor 258, memory 282, and other aspects described herein.

In some aspects, a processor may be configured to perform various operations, such as those associated with the methods described herein, and transmit (output) to or receive (obtain) data from another interface that is configured to transmit or receive, respectively, the data.

As above, FIGS. 3A, 3B, 3C, and 3D depict various example aspects of data structures that may be used in wireless communication network 100 of FIG. 1.

Wireless communication systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 3B and 3D) into multiple orthogonal subcarriers. Each subcarrier may be modulated with data. Modulation symbols may be sent in the frequency domain with OFDM and in the time domain with SC-FDM.

A wireless communication frame structure may be frequency division duplex (FDD), in which for a particular set of subcarriers and subframes within the set of subcarriers are dedicated for either DL or UL. Wireless communication frame structures may also be time division duplex (TDD), in which for a particular set of subcarriers and subframes within the set of subcarriers are dedicated for both DL and UL.

In FIGS. 3A and 3C, the wireless communication frame structure is TDD where D is DL, U is UL, and X is flexible for use between DL/UL. UEs may be configured with the slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot configuration. Subframes may also include mini-slots, which generally have fewer symbols than an entire slot. Other wireless communication technologies may have a different frame structure and/or different channels.

Generally, the number of slots within a subframe is based on a slot configuration and a numerology. For slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ}×15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 3A, 3B, 3C, and 3D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 3A, 3B, 3C, and 3D, a resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 3A, some of the REs carry reference (pilot) signals (RS) for a UE (e.g., UE 104 of FIGS. 1 and 2). The RS may include demodulation RS (DMRS) and channel state information reference signals (CSI-RS) for channel estimation at the UE. The RS may also include beam measurement RS (BRS), beam refinement RS (BRRS), and phase tracking RS (PT-RS).

FIG. 3B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol.

A primary synchronization signal (PSS) may be within symbol 2 of particular subframes of a frame. The PSS is used by a UE (e.g., 104 of FIGS. 1 and 2) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 3C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may also transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 3D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

FIG. 13 depicts an example disaggregated base station 1300 architecture. The disaggregated base station 1300 architecture may include one or more central units (CUs) 1310 that can communicate directly with a core network 1320 via a backhaul link, or indirectly with the core network 1320 through one or more disaggregated base station units (such as a Near-Real Time (Near-RT) RAN Intelligent Controller (RIC) 1325 via an E2 link, or a Non-Real Time (Non-RT) RIC 1315 associated with a Service Management and Orchestration (SMO) Framework 1305, or both). A CU 1310 may communicate with one or more distributed units (DUs) 1330 via respective midhaul links, such as an F1 interface. The DUs 1330 may communicate with one or more radio units (RUS) 1340 via respective fronthaul links. The RUs 1340 may communicate with respective UEs 120 via one or more radio frequency (RF) access links. In some implementations, the UE 104 may be simultaneously served by multiple RUs 1340.

Each of the units, i.e., the CUS 1310, the DUs 1330, the RUs 1340, as well as the Near-RT RICs 1325, the Non-RT RICs 1315 and the SMO Framework 1305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 1310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 1310. The CU 1310 may be configured to handle user plane functionality (i.e., Central Unit-User Plane (CU-UP)), control plane functionality (i.e., Central Unit-Control Plane (CU-CP)), or a combination thereof. In some implementations, the CU 1310 can be logically split into one or more CU-UP units and one or more CU-CP units. The CU-UP unit can communicate bidirectionally with the CU-CP unit via an interface, such as the E1 interface when implemented in an O-RAN configuration. The CU 1310 can be implemented to communicate with the DU 1330, as necessary, for network control and signaling.

The DU 1330 may correspond to a logical unit that includes one or more base station functions to control the operation of one or more RUs 1340. In some aspects, the DU 1330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 1330 may further host one or more low PHY layers. Each layer (or module) can be implemented with an interface configured to communicate signals with other layers (and modules) hosted by the DU 1330, or with the control functions hosted by the CU 1310.

Lower-layer functionality can be implemented by one or more RUs 1340. In some deployments, an RU 1340, controlled by a DU 1330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 1340 can be implemented to handle over the air (OTA) communication with one or more UEs 104. In some implementations, real-time and non-real-time aspects of control and user plane communication with the RU(s) 1340 can be controlled by the corresponding DU 1330. In some scenarios, this configuration can enable the DU(s) 1330 and the CU 1310 to be implemented in a cloud-based RAN architecture, such as a vRAN architecture.

The SMO Framework 1305 may be configured to support RAN deployment and provisioning of non-virtualized and virtualized network elements. For non-virtualized network elements, the SMO Framework 1305 may be configured to support the deployment of dedicated physical resources for RAN coverage requirements which may be managed via an operations and maintenance interface (such as an O1 interface). For virtualized network elements, the SMO Framework 1305 may be configured to interact with a cloud computing platform (such as an open cloud (O-Cloud) 1390) to perform network element life cycle management (such as to instantiate virtualized network elements) via a cloud computing platform interface (such as an O2 interface). Such virtualized network elements can include, but are not limited to, CUs 1310, DUs 1330, RUs 1340 and Near-RT RICs 1325. In some implementations, the SMO Framework 1305 can communicate with a hardware aspect of a 4G RAN, such as an open eNB (O-eNB) 1311, via an O1 interface. Additionally, in some implementations, the SMO Framework 1305 can communicate directly with one or more RUs 1340 via an O1 interface. The SMO Framework 1305 also may include a Non-RT RIC 1315 configured to support functionality of the SMO Framework 1305.

The Non-RT RIC 1315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC X25. The Non-RT RIC 1315 may be coupled to or communicate with (such as via an Al interface) the Near-RT RIC 1325. The Near-RT RIC 1325 may be configured to include a logical function that enables near-real-time control and optimization of RAN elements and resources via data collection and actions over an interface (such as via an E2 interface) connecting one or more CUs 1310, one or more DUs 1330, or both, as well as an O-eNB, with the Near-RT RIC 1325.

In some implementations, to generate AI/ML models to be deployed in the Near-RT RIC 1325, the Non-RT RIC 1315 may receive parameters or external enrichment information from external servers. Such information may be utilized by the Near-RT RIC 1325 and may be received at the SMO Framework 1305 or the Non-RT RIC 1315 from non-network data sources or from network functions. In some examples, the Non-RT RIC 1315 or the Near-RT RIC 1325 may be configured to tune RAN behavior or performance. For example, the Non-RT RIC 1315 may monitor long-term trends and patterns for performance and employ AI/ML models to perform corrective actions through the SMO Framework 1305 (such as reconfiguration via O1) or via creation of RAN management policies (such as A1 policies).

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. An apparatus for wireless communication, the apparatus comprising:
memory comprising computer-executable instructions; and
one or more processors configured to, individually or collectively, execute the computer-executable instructions and cause the apparatus to:
signal, to a network entity, one or more capabilities of the apparatus for uplink panel switching associated with simultaneous multi-panel uplink transmission; and
receive, from the network entity, an uplink panel switching configuration for the apparatus in response to the one or more capabilities of the apparatus.

2. The apparatus of claim 1, wherein the simultaneous multi-panel uplink transmission comprises a first uplink transmission by the apparatus on a first component carrier (CC) using a first antenna panel and, simultaneous with the first uplink transmission by the apparatus, a second uplink transmission by the apparatus on a second CC using a second antenna panel.

3. The apparatus of claim 1, wherein the simultaneous multi-panel uplink transmission comprises simultaneous uplink transmission by the apparatus on a component carrier (CC) using a first antenna panel and a second antenna panel.

4. The apparatus of claim 1, wherein the one or more processors are further configured to, individually or collectively, cause the apparatus to:
signal, to the network entity, one or more capabilities of the apparatus for uplink port switching associated with multiple-input multiple-output (MIMO) uplink transmission; and
receive, from the network entity, an uplink port switching configuration for the apparatus in response to the one or more capabilities of the apparatus for uplink port switching.

5. The apparatus of claim 1, wherein the one or more processors are configured to, individually or collectively, cause the apparatus to:
signal the one or more capabilities of the apparatus for uplink panel switching for each band combination of a plurality of band combinations.

6. The apparatus of claim 1, wherein the one or more processors are configured to, individually or collectively, cause the apparatus to:
signal, to the network entity, the one or more capabilities of the apparatus for uplink panel switching via radio resource control signaling (RRC) or medium access control control element (MAC CE) signaling.

7. The apparatus of claim 1, wherein the one or more capabilities of the apparatus for uplink panel switching comprise a BandCombination-UplinkPanelSwitch parameter indicating a band combination and whether uplink panel switching is supported by the apparatus for the band combination.

8. The apparatus of claim 1, wherein the one or more capabilities of the apparatus for uplink panel switching comprise a capability of the apparatus for simultaneous multi-panel uplink transmission with frequency division multiplexing (FDM).

9. The apparatus of claim 1, wherein the one or more capabilities of the apparatus for uplink panel switching comprise a capability of the apparatus for simultaneous multi-panel uplink transmission with spatial division multiplexing (SDM).

10. The apparatus of claim 1, wherein the one or more capabilities of the apparatus for uplink panel switching comprise a capability for single downlink control information (sDCI) scheduled simultaneous multi-panel uplink transmission.

11. The apparatus of claim 1, wherein the one or more capabilities of the apparatus for uplink panel switching comprise a capability for multiple downlink control information (mDCI) scheduled simultaneous multi-panel uplink transmission.

12. The apparatus of claim 1, wherein the one or more capabilities of the apparatus for uplink panel switching comprise a capability for simultaneous multi-panel uplink transmission on a first physical uplink control channel (PUCCH) and a second PUCCH.

13. The apparatus of claim 1, wherein the one or more capabilities of the apparatus for uplink panel switching comprise a capability for simultaneous multi-panel uplink transmission on a physical uplink control channel (PUCCH) and a physical uplink shared channel (PUCSH).

14. The apparatus of claim 1, wherein the one or more capabilities of the apparatus for uplink panel switching comprise a capability for simultaneous multi-panel uplink transmission on a first physical uplink shared channel (PUCSH) and a second PUSCH.

15. The apparatus of claim 1, wherein the uplink panel switching configuration for the apparatus comprises an indication of whether uplink panel switching is configured for each band combination of a plurality of band combinations.

16. The apparatus of claim 1, wherein the uplink panel switching configuration comprises an uplinkPanelSwitching parameter indicating a band combination and whether uplink panel switching is configured for the band combination.

17. The apparatus of claim 1, wherein the uplink panel switching configuration is received via radio resource control signaling (RRC) or medium access control control element (MAC CE) signaling.

18. The apparatus of claim 1, wherein the one or more capabilities includes a minimum switching gap threshold duration.

19. The apparatus of claim 18, wherein the one or more processors are further configured to, individually or collectively, cause the apparatus to:
receive signaling triggering the apparatus for uplink panel switching for a first uplink transmission in a first time period and a second uplink transmission in a second time period, wherein second time period is scheduled at least the minimum switching gap threshold duration after the first time period.

20. The apparatus of claim 1, wherein the one or more processors are further configured to, individually or collectively, cause the apparatus to:
receive first signaling scheduling a non-simultaneous uplink transmission on a first uplink component carrier (UL CC) in a first time period; and
receive second signaling scheduling a simultaneous multi-panel uplink transmission on a second UL CC in a second time period after the first time period,
wherein the second time period is scheduled at least a minimum switching gap threshold duration after the first time period.

21. The apparatus of claim 1, wherein the one or more processors are further configured to, individually or collectively, cause the apparatus to:
receive first signaling scheduling a simultaneous multi-panel uplink transmission on a first uplink component carrier (UL CC) in a first time period; and
receive second signaling scheduling a non-simultaneous uplink transmission on a second UL CC in a second time period after the first time period,
wherein the second time period is scheduled at least a minimum switching gap threshold duration after the first time period.

22. The apparatus of claim 1, wherein the one or more processors are further configured to, individually or collectively, cause the apparatus to:
receive first signaling scheduling a non-simultaneous uplink transmission on a first uplink component carrier (UL CC) in a first time period in which the apparatus is not configured to support simultaneous multi-panel uplink transmissions on a same UL CC; and
receive second signaling scheduling a simultaneous multi-panel uplink transmission on the first UL CC in a second time period after the first time period,
wherein the second time period is scheduled at least a minimum switching gap threshold duration after the first time period.

23. The apparatus of claim 1, wherein the one or more processors are further configured to, individually or collectively, cause the apparatus to:
receive first signaling scheduling a first non-simultaneous uplink transmission on a first uplink component carrier (UL CC) in a first time period in which the apparatus is configured to support simultaneous multi-panel uplink transmission on the a UL CC; and
receive second signaling scheduling a second non-simultaneous uplink transmission on a second UL CC in a second time period after the first time period,
wherein the second time period is scheduled at least a minimum switching gap threshold duration after the first time period.

24. An apparatus for wireless communication, the apparatus comprising:
memory comprising computer-executable instructions; and
one or more processors configured to, individually or collectively, execute the computer-executable instructions and cause the apparatus to:
receive one or more capabilities of a user equipment (UE) for uplink panel switching associated with simultaneous multi-panel uplink transmission; and
provide an uplink panel switching configuration for the UE in response to the one or more capabilities of the UE.

25. The apparatus of claim 24, wherein the simultaneous multi-panel uplink transmission comprises a first uplink transmission by the UE on a first component carrier (CC) using a first UE antenna panel and, simultaneous with the first uplink transmission by the UE, a second uplink transmission by the UE on a second CC using a second UE antenna panel.

26. The apparatus of claim 24, wherein the simultaneous multi-panel uplink transmission comprises simultaneous uplink transmission by the UE on a component carrier (CC) using a first UE antenna panel and a second UE antenna panel.

27. The apparatus of claim 24, wherein the one or more processors are further configured to, individually or collectively, cause the apparatus to:
receive one or more capabilities of the UE for uplink port switching associated with multiple-input multiple-output (MIMO) uplink transmission; and
provide an uplink port switching configuration for the UE in response to the one or more capabilities of the UE for uplink port switching.

28. The apparatus of claim 24, wherein the one or more capabilities of the UE for uplink panel switching comprises one or more capabilities of the UE for each band combination of a plurality of band combinations.

29. A method for wireless communication by a user equipment (UE), the method comprising:
signaling, to a network entity, one or more capabilities of the UE for uplink panel switching associated with simultaneous multiple-panel (multi-panel) uplink transmission; and
receiving, from the network entity, an uplink panel switching configuration for the UE in response to the one or more capabilities of the UE.

30. A method for wireless communication by a network entity, the method comprising:
receiving one or more capabilities of a user equipment (UE) for uplink panel switching associated with simultaneous multiple-panel (multi-panel) uplink transmission; and
providing an uplink panel switching configuration for the UE in response to the one or more capabilities of the UE.
